(19) United States
(12) Patent Application Publication
(10) Pub. No.: US 2015/0278866 A1
(43) Pub. Date: Oct. 1, 2015

(54) SYSTEM AND METHOD FOR GEO-LOCATION BASED CONTENT DELIVERY

(71) Applicant: Blue Calypso, LLC, Dallas, TX (US)

(72) Inventor: Andrew E. Levi, Dallas, TX (US)

(73) Assignee: Blue Calypso, LLC, Dallas, TX (US)

(21) Appl. No.: 14/670,366

(22) Filed: Mar. 26, 2015

Related U.S. Application Data
(60) Provisional application No. 61/970,844, filed on Mar. 26, 2014.

(51) Int. Cl. G06Q 30/02; G06Q 10/08

(52) U.S. Cl. CPC G06Q 30/0261; G06Q 10/087

(57) ABSTRACT

A system and method for generating and distributing location-based brochures is disclosed. The system includes a network, an intermediary server connected to the network, a set of merchant devices connected to the network, a set of patrons connected to the network, a set of third party data providers connected to the network. The intermediary server is programmed to store and execute instructions that cause the system to perform the method. The method includes the steps of receiving a set of brochure data, receiving a request for a brochure, receiving a set of third party data, receiving a current inventory level, generating the brochure from the set of brochure data, the set of third party data, and the current inventory level in response to the request for the brochure, receiving a selection of the brochure, and generating a coupon based on the selection.

### CROSS REFERENCE TO RELATED APPLICATION

This application claims priority to U.S. Provisional Application No. 61/970,844 filed Mar. 26, 2014. The above identified patent application is incorporated herein by reference in its entirety to provide continuity of disclosure.

### FIELD OF THE INVENTION

The present disclosure relates to systems and methods for delivering electronic content and coupon incentives to patrons of brick and mortar stores based on geo-location data.

### BACKGROUND OF THE INVENTION

For many years, merchants have sought to improve profit through higher margin, and sales volume and reduced operating costs. Volume and margin can be affected by the geographic location of goods and services. Volume and margin can also be affected by other factors related to geographic location such as weather and population density.

Paper coupons and printed brochures have been used to inform the patron about price incentives based on region. However, paper systems are slow, and lack the flexibility to be customized to small areas, specific products, and/or real time inventory and shipping data and are difficult if not impossible to track.

The prior art has attempted to solve these problems with limited success. For example, U.S. Pat. No. 7,650,431 to Wang et al. discloses a system for providing location-based content to observers to requesting devices. The system aggregates advertisements by collecting advertisements from multiple advertisement sources, extracting data from the collected advertisements, and storing the extracted data in a common format. The system identifies the serving area location of the advertisements. The system receives queries for advertisements from user devices. The system identifies matching advertisements and ranks the advertisements based on a location associated with each query and a location associated with each advertisement. The system provides the ranked advertisements in response to the request to the user device. However, the system cannot generate customized electronic content.

U.S. Publication No. 2011/0288917 to Wanek et al. discloses a system for sending advertisements to mobile devices based on user demographics, location, weather, and time. A query is submitted to the advertisement system by a user of a device to a content service, such as a map service, to search for content requested from the device, such as from an application seeking to retrieve one or more ads to publish on the mobile device. The content service submits the query to the advertisement system to identify advertisements that match the query. After identifying matching advertisements as candidate advertisements, the advertisement system ranks the candidate advertisements based on a location associated with a query and a location associated with the advertisement and other matching criteria, such as demographics, weather, time, and mode of transportation. The location associated with the query is the location of the user's mobile device represented by the location of the device or a query location derived from the query itself. However, the system in Wanek is susceptible to imprecise query criteria, leading to mismatched advertisements.

U.S. Publication No. 2013/0054366 to Roundtree et al. discloses a system for directing self-targeted content to users who are interested in receiving advertisements. A user creates a persona that defines a number of characteristics. The user provides opinions on brands. The characteristics of the personas are used by advertisers to define members of a target audience. Based on the brand opinions, the system generates a prediction of the likelihood that the user has a number of characteristics. The predictions are made by matching user demographics with demographic tags and triggers provided by advertisers.

Therefore, there is a need in the art for a system to gather, organize, and transform geographic location based information and to deliver electronic content which reflects circumstances related to the geographic location, the patron, and to the product.

### SUMMARY

A system and method for generating and distributing location-based electronic content is disclosed. The system includes a network, an intermediary server device connected to the network, a set of merchant devices connected to the network, a set of patron devices connected to the network, a set of third party data providers connected to the network. A set of beacons is provided that is in radio frequency communication with the set of patron devices. The intermediary server device is programmed to store and execute instructions that cause the system to perform the method.

The system receives a set of requirements and set-up data from a merchant to affect the timing and content of the set of electronic content. The system then responds to a set of triggers in the set-up data to fetch data in the database and third party data to construct a set of electronic content that is transmitted to patrons based at least in part on their location.

### BRIEF DESCRIPTION OF THE DRAWINGS

The disclosed embodiments will be described with reference to the accompanying drawings.

FIG. 1A is a block diagram of a preferred embodiment of the system architecture.

FIG. 1B is a schematic diagram of a brick and mortar store with installed beacons of a preferred embodiment.

FIG. 2A is a sequence chart of a preferred method of generating and sending electronic content.

FIG. 2B is a flowchart of a preferred method of responding to an inventory trigger.

FIG. 2C is a sequence chart of a preferred method of generating a beacon trigger.

FIG. 2D is a flowchart of an alternate preferred method of generating and sending electronic content.

FIG. 3A is a sequence chart of a preferred method of generating electronic content for distribution.

FIG. 3B is a flow chart of an alternate preferred method of generating electronic content for distribution based on a beacon signal.

FIG. 4 is a sequence chart of a preferred method of allocating coupon value in electronic content.

FIGS. 5A-5R is an example of preferred computer code to generate electronic content based on a beacon trigger.

FIGS. 6A-6M is an example of preferred computer code to generate electronic content.

FIG. 7 is a drawing of a preferred form of an information kiosk display.

### DETAILED DESCRIPTION

It will be appreciated by those skilled in the art that aspects of the present disclosure may be illustrated and described in any of a number of patentable classes or contexts including any new and useful process or machine or any new and useful improvement. Aspects of the present disclosure may be implemented entirely in hardware, entirely in software (including firmware, resident software, micro-code, etc.) or combining software and hardware implementation that may all generally be referred to herein as a “circuit,” “module.” “component,” or “system.” Each hardware device is understood to include a computer processor, modem, communication capability, display capability and functional input and output devices. Typical of this hardware is a computer server such as Microsoft Windows Server 2008 R2 Standard and a smartphone device such as a Samsung Galaxy S4. Further, aspects of the present disclosure may take the form of a computer program product embodied in one or more computer readable media having computer readable program code embodied thereon.

It will be appreciated by those skilled in the art that the described embodiments disclose significantly more than an abstract idea and include technical advancements in the field of data processing and a transformation of data which is directly related to real world objects and situations and enable a computer system to operate more efficiently and solve a problem particular to the Internet with a technical solution particular to the Internet.

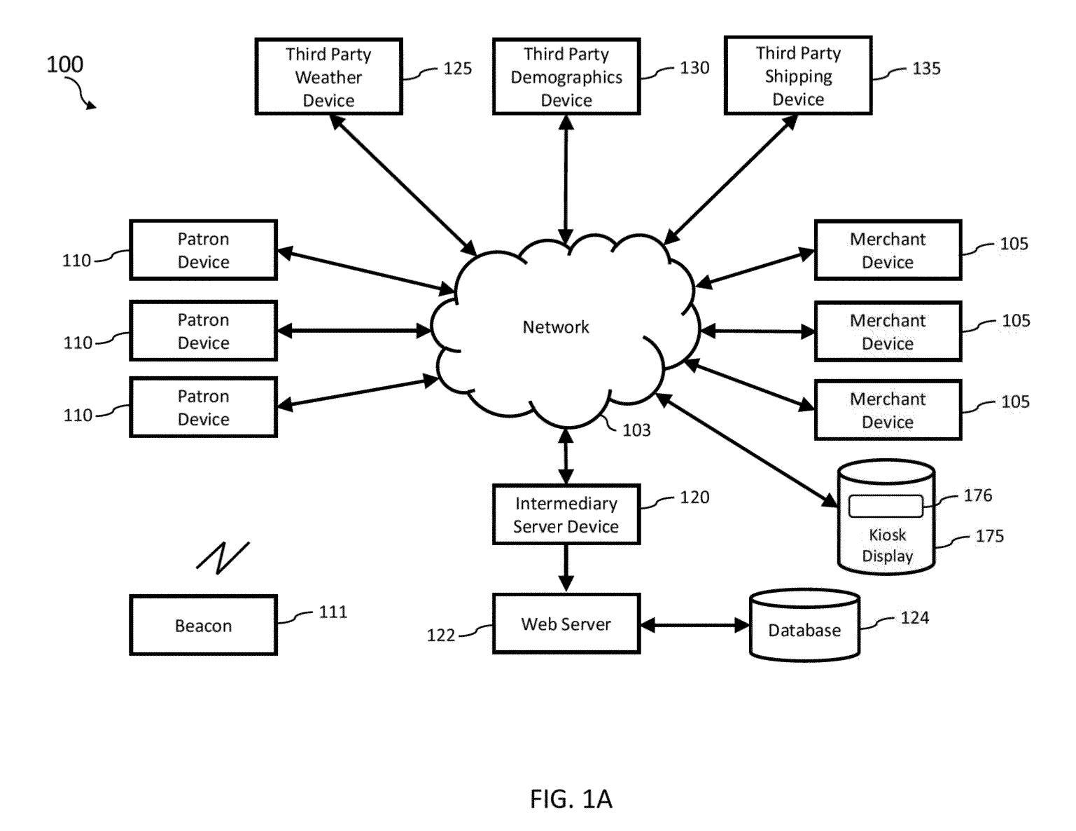

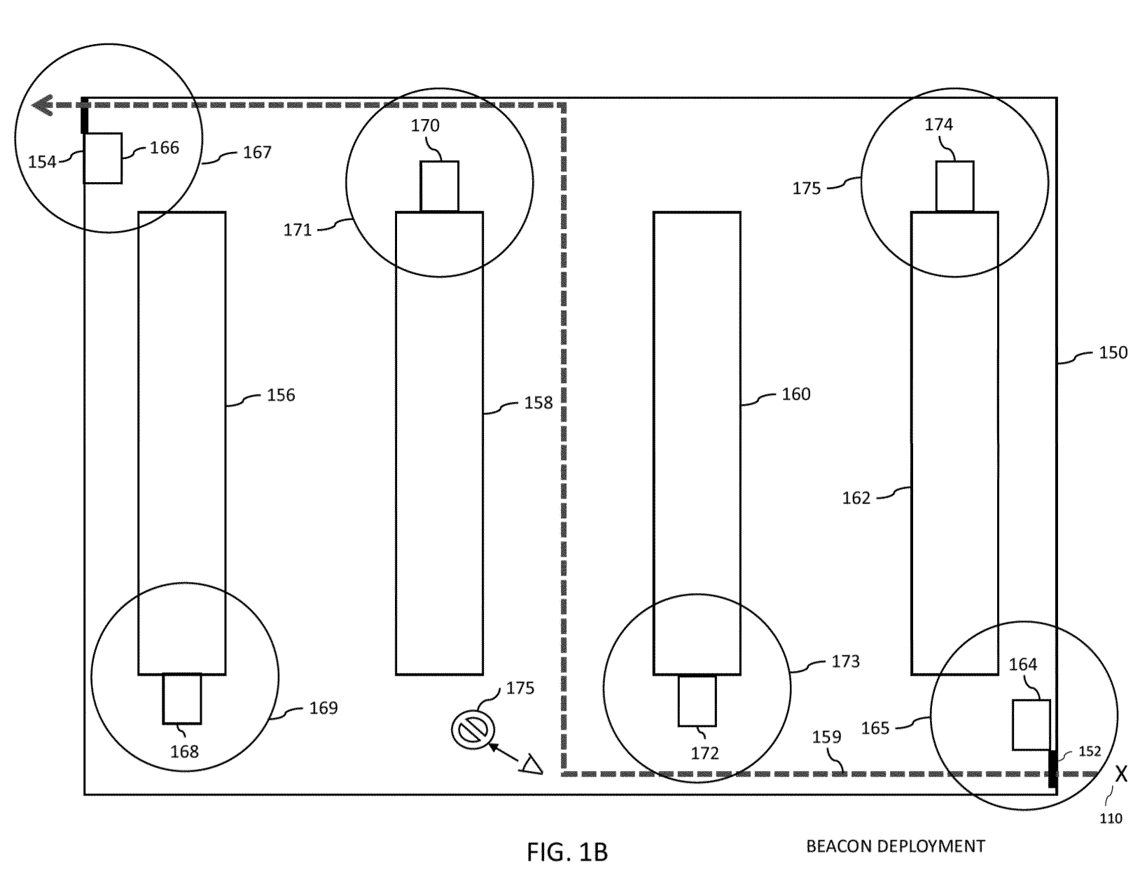

Referring to FIG. 1A, content management system 100 includes intermediary server device 120 connected to network 103. In a preferred embodiment, intermediary server device 120 is connected to web server 122 and database 124. In a preferred embodiment, the intermediary server device comprises the web server and an SQL server, both having the following specifications:

| | |
|---|---|
| OS Name | Microsoft Windows Server 2008 R2 Standard |
| Version | 6.1.7601 Service Pack 1 Build 7601 |
| OS Manufacturer | Microsoft Corporation |
| System Manufacturer | Supermicro |
| System Model | X8DTN |
| System Type | x64-based PC |
| Processor | Intel(R) Xeon(R) CPU E5620 @ 2.40 GHz, |
| | 2401 Mhz, 4 Core(s), 8 Logical Processor(s) |
| Processor | Intel(R) Xeon(R) CPU E5620 @ 2.40 GHz, |
| | 2401 Mhz, 4 Core(s), 8 Logical Processor(s) |
| BIOS Version/Date | American Megatrends Inc. 2.1c, Oct. 28, 2011 |
| SMBIOS Version | 2.6 |
| Hardware Abstraction | Version = “6.1.7601.17514” |
| Layer | |
| Installed Physical | 24.0 GB |
| Memory (RAM) | |
| Total Physical Memory | 24.0 GB |
| Description | Disk drive |
| Manufacturer | (Standard disk drives) |
| Model | Adaptec Array SCSI Disk Device |
| Bytes/Sector | 512 |
| Media Loaded | Yes |
| Media Type | Fixed hard disk |
| Partitions | 1 |
| SCSI Bus | 4 |
| SCSI Logical Unit | 0 |
| SCSI Port | 6 |
| SCSI Target ID | 0 |
| Sectors/Track | 63 |
| Size | 837.00 GB (898,718,768,640 bytes) |
| Total Cylinders | 109,263 |
| Total Sectors | 1,755,310,095 |
| Total Tracks | 27,862,065 |
| Tracks/Cylinder | 255 |
| Partition | Disk #0, Partition #0 |
| Partition Size | 837.00 GB (89.8,719,809,536 bytes) |
| Partition Starting | 1,048,576 bytes |
| Offset | |

Patron devices 110 communicates with intermediary server device 120 through network 103. Merchant devices 105 communicate with intermediary server device 120 through network 103. Third party weather device 125 is connected to network 103 and communicates with intermediary server device 120. Third party demographics device 130 is connected to network 103 and communicates with intermediary server device 120. Third party shipping device 135 is connected to network 103 and communicates with intermediary server device 120.

Kiosk display 175, in one preferred embodiment, is a computer device having an outward facing display face 176. The kiosk display communicates with each of the other devices through network 103. In another preferred embodiment, kiosk display is a printed cardboard cylinder that is freestanding and static. In another embodiment, the kiosk display includes an on-board integrated beacon.

In one preferred embodiment, network 103 is the internet. In another preferred embodiment, network 103 is a wide area network including a cellular network. In alternate embodiments, network 103 may also include a local area network and/or Wi-Fi network connected to the wide area network.

In a preferred embodiment, each of patron device 110 is a smart phone. In other embodiments, each patron device 110 is a PC or tablet computer. In a preferred embodiment, the patron device has the following specifications:

| | |
|---|---|
| Description | Samsung Galaxy S4 |
| Manufacturer | Samsung |
| Model | SPH-L720 |
| Carrier | Sprint |
| Hardware Version | L720.08 |
| Android Version | 4.4.2 |
| Baseband Version | L720VPUFNG2 |
| Kernel Version | 3.4.0-2162929 |
| Build Number | KOT48H.L720VPUFNG2 |
| Memory | 16 GB |

Beacon 111 is provided and transmits a coded beacon signal to patron device 110. A beacon signal comprises a low-power transmission that enables a smartphone or other device to perform actions when in close proximity. In a preferred embodiment, the beacon uses Bluetooth low energy proximity sensing to transmit a unique identifier which is received by the smartphone and then decoded to determine a physical location.

In a preferred embodiment, the beacon is a rad beacon X2 10TI. The rad beacon X2 is a standalone proximity beacon which uses iBeacon and altBeacon technology. The rad beacon has a range of transmission rates between of 100 milliseconds with a battery life of nine months to a 1000 milliseconds rate with a battery life of 92 months. The rad beacon X2 has a transmit power of between +4 dbm to −20 dbm and a line-of-sight transmission range of 5-50 meters. The rad beacon X2 is available from Radius Networks, Inc. of Washington, D.C.

In a preferred embodiment, each beacon is assigned a unique serial number which is correlated to a specific physical location which is stored in a table in the database. Other information is also stored in the database correlated to serial number. In a preferred embodiment, this information includes installation time for the beacon, battery life remaining for each beacon, the beacon manufacturer and product number in the store where the beacon is physically located.

In a preferred embodiment, third party weather device 125 is a weather service data provider such as the National Oceanic and Atmospheric Administration (“NOAA”). Other weather data providers known in the art may be employed.

In a preferred embodiment, third party demographics device 130 is a demographic data provider such as the U.S. Census Bureau. Other third party demographic data providers may be employed.

In a preferred embodiment, third party shipping device 135 is a shipping data provider such as the United States Postal Service, Federal Express, and/or UPS.

Referring to FIG. 1B, the preferred embodiment of an exemplary beacon deployment is described. Brick and mortar store 150 includes entrance 152 and exit 154. Brick and mortar store 150 includes product shelving bays 156, 158, 160 and 162.

Beacon 164 is located adjacent entrance 152. Beacon 166 is located adjacent exit 154. Beacon 164 includes transmission perimeter 165. Beacon 166 includes transmission perimeter 167.

In one preferred embodiment, beacons 168, 170, 172 and 174 are installed at endcaps of product shelving bays 156, 158, 160 and 162, respectively. Beacons 168, 170, 172 and 174 include transmission perimeters 169, 171, 173 and 175, respectively. In other embodiments, beacons can be located in other places and outside the brick and mortar store.

Path 159 shows an exemplary path of travel of patron device 110 through brick and mortar store 150. Along the path, patron device 110 enters and exits transmission perimeters 165, 173, 171 and 167.

Kiosk display 175 is shown in an exemplary placement adjacent path 159, within view of patron device 110.

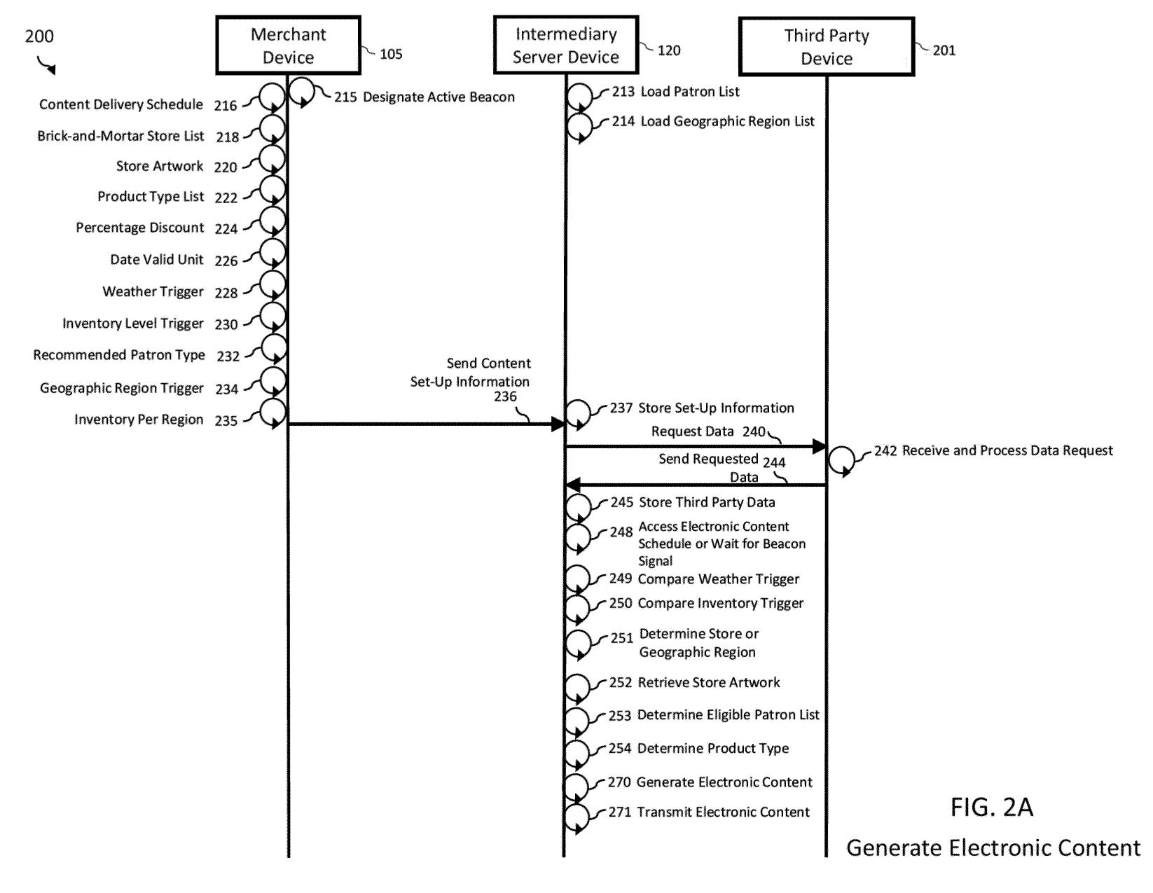

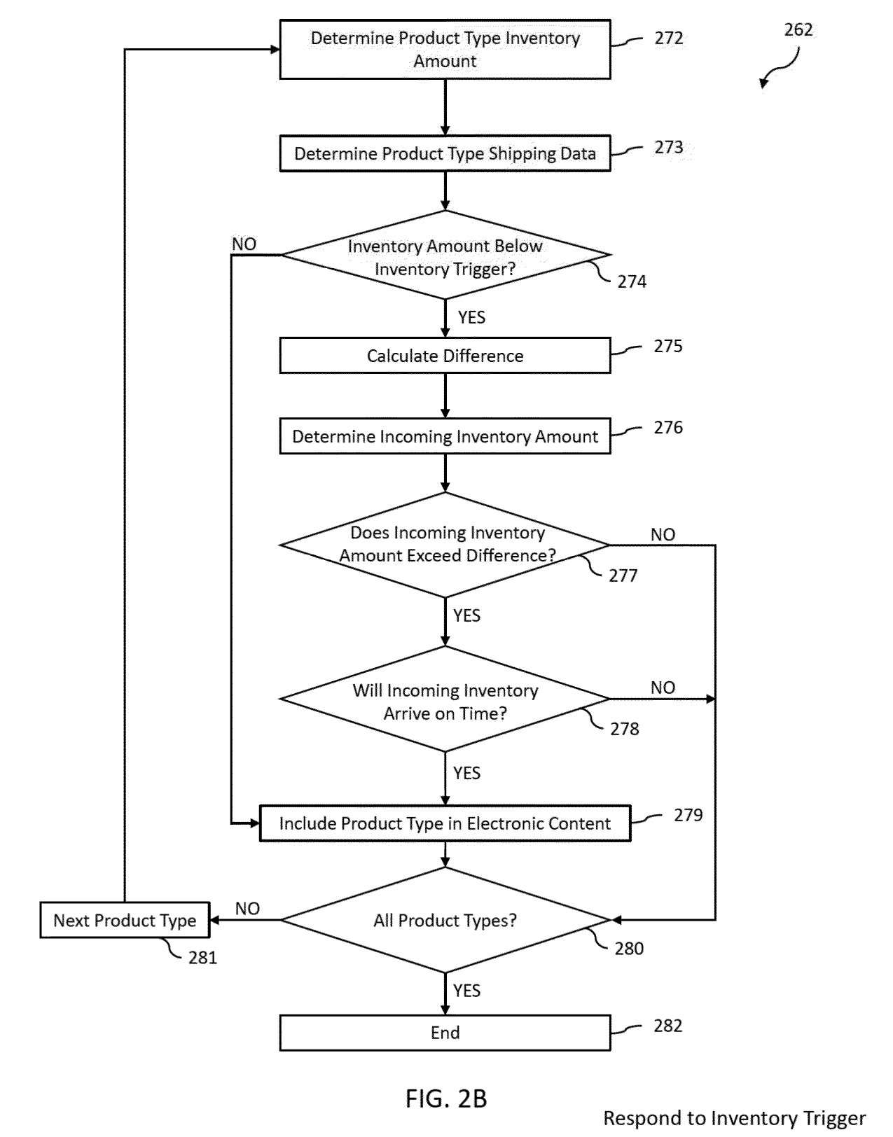

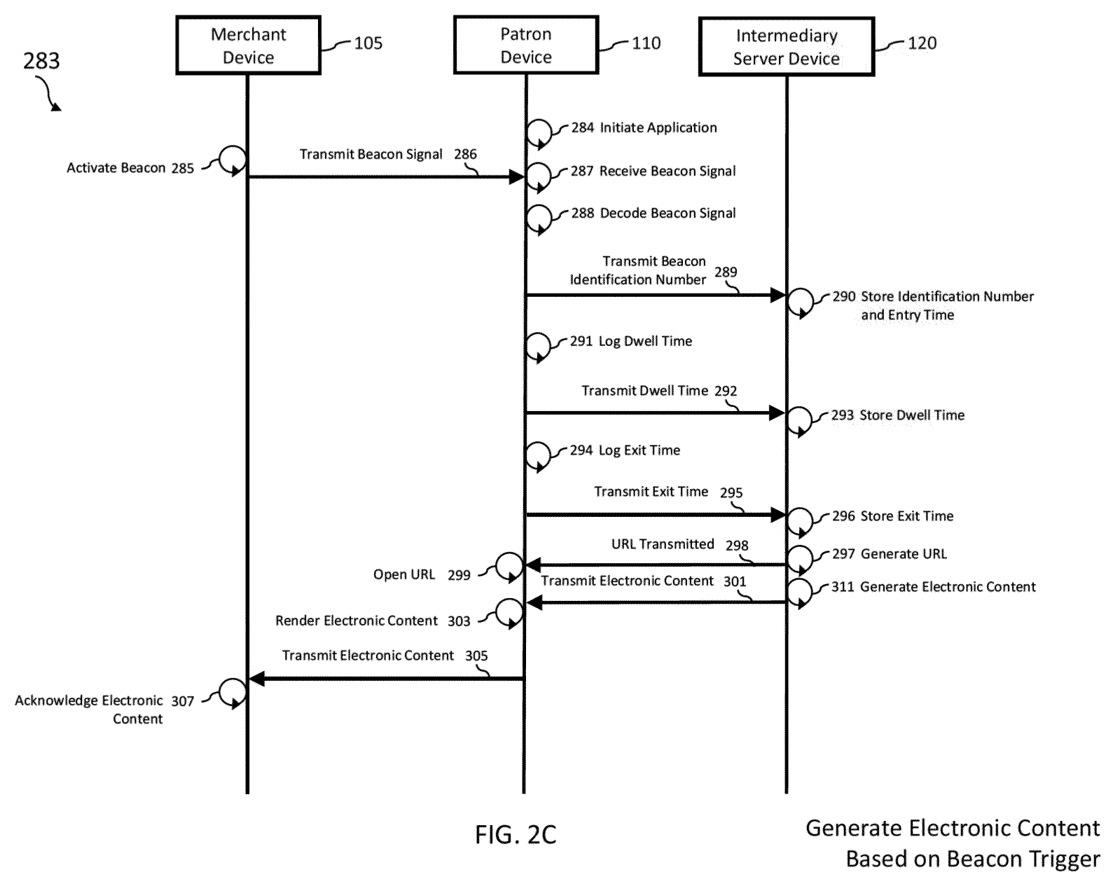

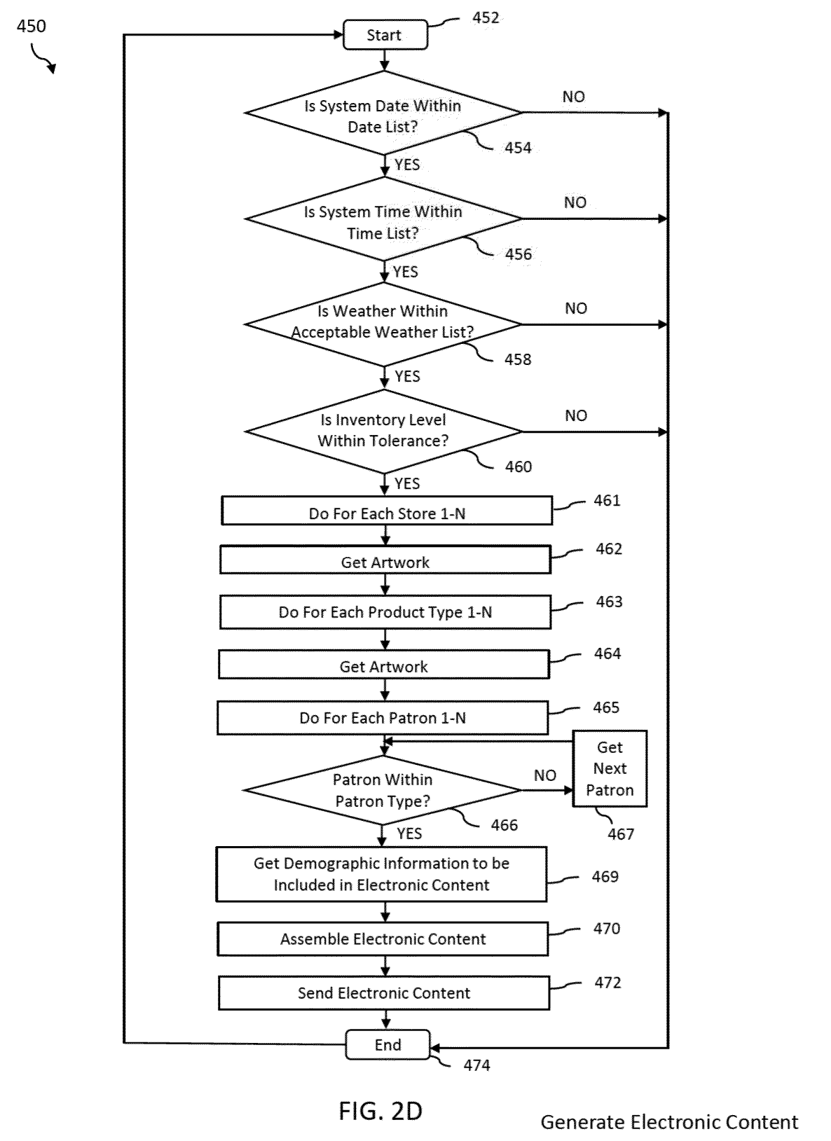

Referring to FIG. 2A, a sequence chart of a preferred embodiment of a method 200 to generate electronic content is disclosed.

At step 213, the intermediary server device loads a patron list which includes identifying information and demographic information for each patron. At step 214, the intermediary server device loads a set of geographic information comprising specific areas of the country, state, region, brick and mortar store location and/or product location within a brick and mortar store.

At step 215, merchant device 105 begins entry of the electronic content and delivery setup information. At step 215, the merchant device designates an active beacon. At step 216, the merchant device determines an electronic content delivery schedule. The electronic content delivery schedule includes a “date trigger” of the dates and times that the electronic content will be sent to each patron. At step 218, merchant device 105 determines the identity and geographic location of a set of brick and mortar stores to be included in the electronic content. At step 220, merchant device 105 determines the store artwork. The store artwork can include photographs of the actual brick and mortar store, video images, product photographs, packaging photographs and maps to particular stores, maps within particular stores to product display sites and/or kiosk display sites, and pictures of local landmarks. At step 222, merchant device 105 provides a listing of product types offered at each brick and mortar store. In a preferred embodiment, this list can be a flat list that includes only product serial number and an alphanumeric designator. In another preferred embodiment, the list can include a product tracking number assigned to each product type, product specifications, prices and product photographs. At step 224, merchant device 105 provides a percentage discount for each product type. The percentage discount can be zero. The percentage discount can include a maximum allowable number of coupons to be sent. At step 226, the “date valid limit” is provided. A “date valid limit” is a preselected set of dates and times when the electronic content will be valid at each brick and mortar store and for each product type. For example, an electronic coupon may only be valid for 30 minutes, at a certain time, on a certain day. At step 228, merchant device 105 provides weather triggers. A “weather trigger” is a set of weather conditions during which sales volume of each particular product type is anticipated to be at a certain level, e.g. higher or lower. An example of an anticipated sales volume for weed eaters in good weather is “high” and in bad weather is “low”. In a preferred embodiment, the weather triggers include current temperature and pressure and 2-week forecast temperature and pressure correlated to each product type. In another embodiment, current and forecast wind speed and direction are also included. At step 230, merchant device 105 provides inventory level triggers. An “inventory level trigger” is an inventory amount for each specific product type and for each brick and mortar store. For example, an inventory level trigger may be at a high or low inventory level, or a level at which a product is considered overstocked or understocked. At step 232, merchant device 105 provides a recommended patron type. A “recommended patron type” is a set of patron demographics that correlate to frequent purchases of particular product types. In a preferred embodiment, the database contains a list of patron identities and corresponding demographic information. Demographic information can include age, gender, address (or geographic location), interests, hobbies, real and personal property ownership, income level and location.

Other demographic data may also be included. At step 234, merchant device 105 provides a set of geographic region triggers. A “geographic region trigger” is a designation of a geographic region of the country. For example, a geographic region where each product type sells well (or poorly). In another preferred embodiment, the “geographic region triggers” include a smaller geographic region such as the perimeter of a brick and mortar store where each product type sells well (or poorly). In another preferred embodiment, the “geographic region triggers” can include a small geographic region such as the transmission perimeter of an electronic beacon. In a preferred embodiment, the database is preloaded with a list of all relevant geographic regions. At step 235, merchant device 105 determines a current inventory level of each product type for each store and for each region. In one embodiment, the current inventory level includes a product type inventory amount and an “incoming inventory amount” which is in transit. In one embodiment, the incoming inventory amount includes shipping data from a logistics data system resident on merchant device 105. In another embodiment, the shipping data is retrieved from a third party logistics data system, as will be further described below.

At step 236, the electronic content set-up information including the information from steps 216, 218, 220, 222, 224, 226, 228, 230, 232, 234 and 235 is sent to the intermediary server device 120. In one embodiment, only selected set-up information is set to the intermediary server device. At step 237, the information is stored in the database by intermediary server device 120.

At step 240, intermediary server device 120 periodically requests third party data from third party 201. In one embodiment, third party data is weather data for all regions of the United States from NOAA and/or other third party weather data providers. In one embodiment, third party data includes demographic data for all regions of the United States from U.S. Census Bureau and/or other third party demographic data providers. In one embodiment, third party data includes shipping data for any product type inventory ordered by merchant device 105 from a shipping service, such as the United States Postal Service, Federal Express, and UPS. The shipping data includes products in transit, estimated times for arrival at retail locations, and/or amount of each product type in the shipment. At step 242, third party 201 receives and processes the data request. At step 244, third party 201 sends the requested data to intermediary server device 120. At step 245, the third party data is stored in the database.

At step 248, the recursive process of generating and sending electronic content begins. In a preferred embodiment, the method is recursive because it repeats itself for each combination of dates and times, brick and mortar store locations, product types, weather triggers, inventory level triggers, patron types and geographic region triggers, until all eligible electronic content is sent to all eligible patrons.

At step 248, intermediary server device 120 accesses the current system date and time and compares it to the content delivery schedule. If the current system date and time is within the content delivery schedule, the process continues. In an alternate embodiment, if a beacon has been designated, the system waits until a beacon signal is received and decoded to determine the beacon's physical location. In this case, the receipt of the beacon signal is used by the system to trigger the content delivery schedule. At step 249, intermediary server device 120 compares a weather trigger to third party data related to the current weather conditions. If the current weather conditions match the weather trigger within a predetermined set of match tolerances, then the product is included in the electronic content. In a preferred embodiment, a match includes four parameters, current temperature, pressure and 2-week forecast temperature and pressure that all must be within 20% of the pre-set weather trigger. At step 250, intermediary server device 120 compares an inventory trigger to the current inventory level and shipping data to derive a match. If the inventory trigger and inventory level match within a predetermined set of tolerances, then the product type is included in the electronic content. In a preferred embodiment, the tolerance is 20%. At step 251, intermediary server device 120 identifies the stores to which the electronic content will be sent from the brick and mortar store list. In another embodiment, the intermediary server device identifies the geographic region to which the electronic content will be sent from the geographic region trigger. In another preferred embodiment, the geographic region is determined by the intermediary server device according to the steps of FIG. 2C, which will be further described. At step 252, intermediary server device 120 retrieves the retail store artwork from the database. The store artwork is included in the electronic content. At step 253, intermediary server device 120 determines an eligible patron list. In a preferred embodiment, the intermediary server device queries the database and compiles a list of all patrons that match the recommended patron type. At step 254, intermediary server device 120 determines product types to be included in the electronic content. In a preferred embodiment, the product types are drawn from the product type list stored in the database. In another embodiment, the product types are chosen by a prioritization schedule included in the electronic content set-up information.

As seen, the electronic content setup information is transformed by the intermediary server device into a set of match conditions which determines the electronic content and when it is received. Based on the set of match conditions, intermediary server device 120 identifies a set of product types to offer at each brick and mortar store according to the content delivery schedule, and applies the percentage discount for each product type.

At step 270, intermediary server device 120 assembles the art work, percentage discount and any patron demographic information and generates the electronic content. As seen, the set of match conditions is transformed into a set of electronic content that summarizes a product offering and potential product incentives sent as coupons. At step 271, the electronic content is sent.

Referring to FIG. 2B, a preferred method of comparing an inventory trigger 250 will be further described. At step 272, a current inventory level of the selected product type is retrieved from the merchant device or the third party device. At step 273, a product type shipping data is retrieved from the shipping data for any incoming inventory for the product type. In a preferred embodiment, the product type shipping data includes an incoming inventory amount and a delivery time for each product type. At step 274, intermediary server device 120 compares the product type inventory amount to the inventory trigger. If the product type inventory amount is greater than or equal to the inventory trigger, then method 274 proceeds to step 279. If the product type inventory amount is less than the inventory trigger, then the method 271 proceeds to step 275.

At step 275, intermediary server device 120 calculates the difference between the product type inventory amount and the inventory trigger. At step 276, intermediary server device 120 determines the incoming inventory amount from the product type shipping data. At step 277, intermediary server device 120 compares the incoming inventory amount to the difference. If the incoming inventory amount is less than the difference, then the product type is excluded from the electronic content and the method proceeds to step 280. If the incoming inventory amount is equal to or greater than the difference, then the method proceeds to step 278.

At step 278, intermediary server device 120 compares the delivery time to the date trigger to determine whether the incoming inventory amount will arrive on time, i.e., arrive before the date trigger or during the date trigger. If the incoming inventory amount will not arrive on time, then the product type is excluded from the brochure and the method proceeds to step 280. If the incoming inventory amount will arrive on time, then the method proceeds to step 279.

At step 279, the product type is added to the electronic content. At step 280, intermediary server device 120 determines whether each inventory trigger has been compared to each product type amount. If not, then the method proceeds to the next product type in step 281. The method then returns to step 272. If each inventory trigger has been compared to each product type amount, then the method ends at step 282. In this way, the inventory level and the shipping data are transformed into an included product type for the electronic content.

Referring to FIG. 2C, method 283 of generating electronic content based on a beacon trigger will be described.

At step 284, patron device 110 initiates a smartphone application capable of performing the method. At step 285, a beacon located at a brick and mortar store is activated. At step 286, the beacon signal is transmitted. At step 287, the beacon signal is received by patron device 110 and passed to the application. At step 288, patron device 110 decodes the beacon signal to determine its identification number. At step 289, the identification number is transmitted to intermediary server device 120. At step 290, the identification number and entry time are stored in the database. At step 291, patron device 110 logs a dwell time of how long it is in the perimeter. At step 292, the patron device 110 transmits the dwell time to intermediary server device 120. At step 293, the intermediary server device 120 stores the dwell time. At step 294, the patron device logs the exit time of the patron from the perimeter. At step 295, the patron device transmits the exit time to intermediary server device 120. At step 296, the exit time is stored by the intermediary server device 120 in the database. At step 297, the intermediary server device generates a URL that points to a webpage address. In one embodiment, the electronic content located at the web page address is a static product offer and/or coupon. In another preferred embodiment, the intermediary server device employs steps described in relation to FIGS. 2A, 2B and 2D and/or to generate the electronic content that resides at the webpage address. At step 298, the URL is transmitted to the patron device across the URL in a browser. At step 299, the patron device opens a browser and navigates to the URL. At step 311, the intermediary server device 120 generates electronic content based on the physical location, the dwell time and the exit time, as will be further described. At step 301, the electronic content is transmitted via the Internet to patron device 110.

At step 303, patron device 110 decodes and renders the electronic content. At step 305, the electronic content is transmitted to merchant device 105. At step 307, merchant device 105 acknowledges the electronic content. For example, if the electronic content includes a barcode or coupon, the patron device displays the barcode or coupon and merchant device reads and acknowledges the coupon value for the patron.

Referring to FIG. 2D, an alternate method 450 of generating electronic content will be described.

In a preferred embodiment, the alternate method is carried out by the intermediary server device. At step 452, the method begins. At step 454, the intermediary server device locates the system date and compares it to the content delivery schedule and database. If the system date is not within the delivery schedule, then the method proceeds to step 474 and concludes. If the system date is in the delivery schedule, the method moves to step 456. At step 456, the intermediary server device locates the system time and determines if it is within the content delivery schedule. If it is not, then the method moves to step 474 and concludes. If it is, the method moves to step 458.

At step 458, the intermediary server device accesses a stored set of current weather conditions and compares it to a set of acceptable weather conditions located in the weather trigger stored in the database. If the set of current weather conditions is not within the acceptable weather list, the method moves to step 474 and concludes. If the current weather is within the acceptable weather list, then the method moves to step 460.

At step 460, the intermediary server device accesses a current inventory level in the database and compares it to an inventory level provided in the inventory trigger. If the inventory level is not within the inventory trigger, the method moves to step 474. If inventory level is within the inventory trigger, then the method moves to step 461.

At step 461, the intermediary server device enters a do loop for each store 1-N located in the brick and mortar store list. At step 462, the intermediary server device accesses artwork in the database for each store as located in the store artwork in the database. At step 463, the method enters a second do loop for each product type 1-N of the product type list stored in the database. At step 464, the intermediary server device accesses the artwork for each product type as stored in the database. At step 465, the intermediary server device enters a third do loop for each patron in the recommended patron type list stored in the database. At step 466, the intermediary server device compares the current patron type to the recommended patron type. If there is not a match, then the method moves to step 467. At step 467, the next patron is chosen as the current patron and the method returns to step 466. If the current patron type is a match, then the method moves to step 469. At step 469, demographic information for the current patron is accessed and stored. At step 470, the intermediary server device assembles electronic content for the current store, current product and current patron as specified by the do loops. The intermediary server device accesses and includes the date valid limit as stored in the database. At step 472, the intermediary server device sends the electronic content to the current patron, and returns to step 452. If at step 472 all three do loops are exhausted, then the method moves to step 474, where it returns to step 452.

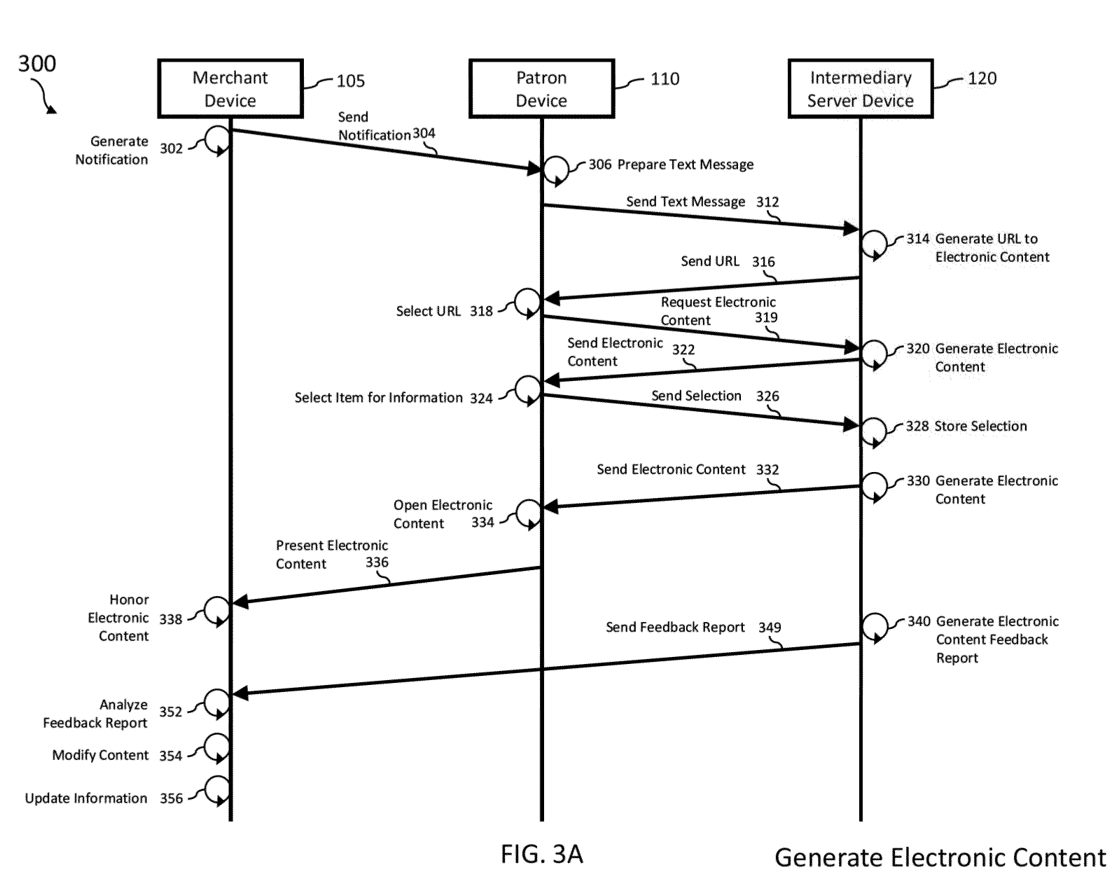

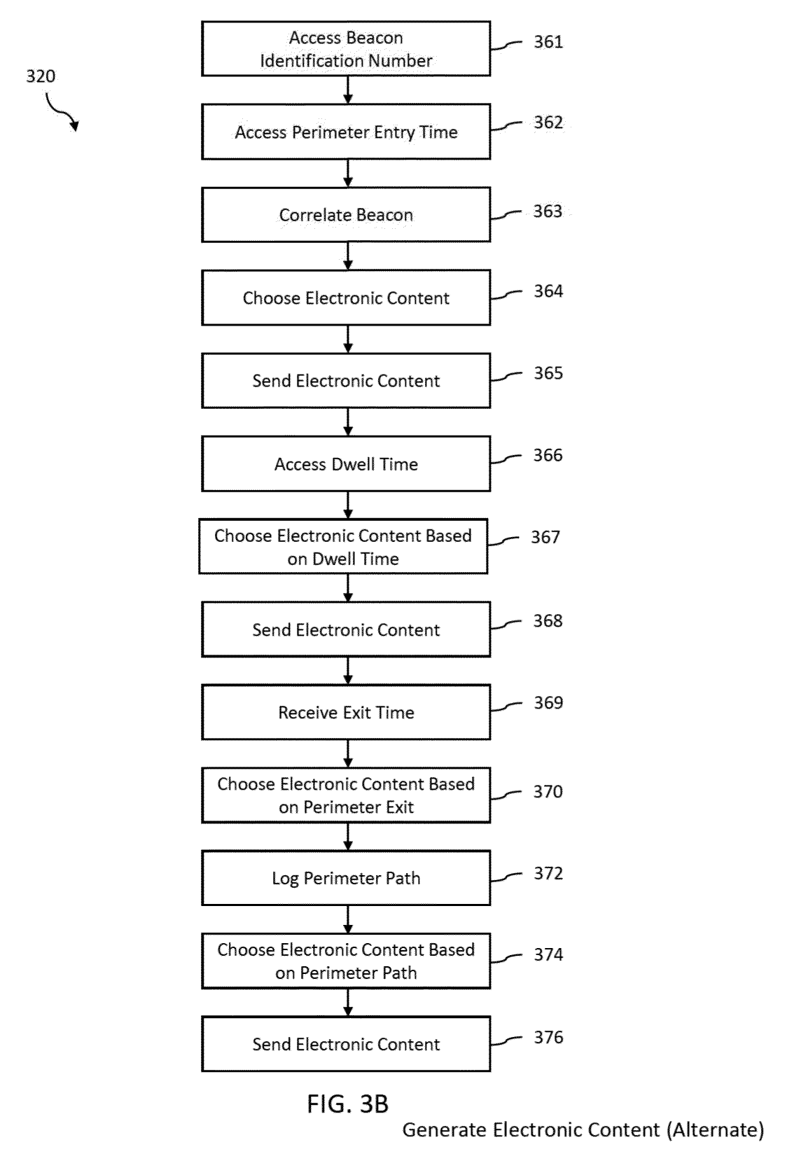

Referring to FIG. 3A, a sequence chart of an alternate preferred embodiment of a method of generating electronic content 300 is described.

At step 302, merchant device 105 generates a marketing notification. In a preferred embodiment, the marketing notification is a text message sent with a designated short code in which merchant device 105 invites patron device 110 to participate. The text message includes a specified product code or a message identifier with which patron device 110 responds. For example, the text message states, “Text ‘discount’ to 12345 to sign-up to receive electronic contents.”

In an alternate preferred embodiment, the content of the marketing notification includes a physical kiosk display posted at the brick and mortar store which is positioned to be read by the patron. The kiosk display produces information displayed to a patron whereby the patron may request product or offer information by sending a text message to a specified number. The kiosk display can be static or dynamic. In one preferred embodiment, the kiosk display images a video presentation. The video presentation may also include data from the merchant or from other patrons or from the intermediary server device.

At step 304, the marketing notification is sent to patron device 110. In a preferred embodiment, patron device 110 pre-registers to receive electronic contents by email or text message. A list of pre-registered patrons is stored in the database.

At step 306, a text message, including the specified product code or message identifier, is prepared by patron device 110. At step 312, the patron device 110 sends the text message to intermediary server device 120 to request the electronic content. At step 314, intermediary server device 120 generates a URL which points to electronic content. In this step, the request is transformed into a URL. At step 316, intermediary server device 120 sends the URL to patron device 110 via either text message or an email. At step 318, patron device 110 selects the URL. At step 319, the electronic content is requested. In an alternate preference embodiment, the text message is sent to a third party who processes the text message, decoding the product information and patron information and notifying the intermediary server device to prepare the electronic content. At step 320, intermediary server device 120 generates the electronic content, as previously described. In this way, the selected URL is transformed into the electronic content. At step 322, intermediary server device 120 sends the electronic content to patron device 110. In a preferred embodiment, the electronic content is customized to the particular demographics of the patron. When the electronic content is “customized” the intermediary server device queries the database to access demographic information about the patron. Pictures, electronic content, similar products and preferences are automatically included in or referenced by the electronic content.

In another embodiment, the electronic content is the same for all patrons entering a particular brick and mortar store. In another embodiment, the electronic content is emailed to the patron and includes a compiled graphic of the electronic content or an interactive link to the on-line electronic content. In alternate embodiments, the message may be a social media message or any other type of electronic message receivable by the patron device.

At step 324, a product item is selected for more information, product reviews, companion products, a coupon and/or a listing of closeout inventory. At step 326, a message is sent to intermediary server device 120 communicating the selected product item. In this way, data related to the selected product item is transformed into a message. At step 328, intermediary server device 120 stores the received selection in database 124.

At step 330, electronic content is generated based on the selection received. The electronic content may include an electronic coupon. In this step, the received selection is transformed into a graphical representation of a coupon. At step 332, the electronic content is sent to the patron device. At step 334, the electronic content is opened for viewing. At step 336, the electronic content is presented to merchant device 105. For example, where the patron device is a smart phone, the patron shows a cashier an image of an electronic coupon on the smart phone's display screen. If the electronic content includes a bar code, then the cashier scans the bar code to redeem the coupon. At step 338, the electronic content is honored by merchant device 105 and redeemed by patron.

At step 340, intermediary server device 120 generates an electric content feedback report based on generating the electronic content in step 330. At step 349, intermediary server device 120 sends the feedback report to merchant device 105. At step 352, the feedback report is analyzed. At step 354, merchant device 105 may modify the electronic content based upon the feedback report. Modifications include, for example, changing a coupon redemption value, changing a product model number and changing the number of coupons available for redemption for all patrons for the product. At step 356, merchant device 105 updates its inventory, saves reports, demographic data, consumer product purchase habits, and retail store performance data.

Referring to FIG. 3B, step 320 of generating electronic content will be further described. At step 361, the intermediary server device receives a beacon identification number. At step 362, the intermediary server device accesses a perimeter entry time. In a preferred embodiment, the entry time is a day, an hour, minute and second format. At step 363, the intermediary server device correlates the beacon identification number to a physical location.

At step 364, electronic content is chosen by the intermediary server device based on entry into the perimeter. In a preferred embodiment, the electronic content is correlated in the database to a particular product according to the physical location of the beacon. In a preferred embodiment, the electronic content is related to products located in the proximity of the corresponding beacon. In another preferred embodiment, the electronic content is related to products similar to those products in the proximity of the beacon. In still another embodiment, the electronic content is information related to products that are alternative to those in the proximity of the beacon. The product types chosen are correlated to beacon location and are stored in and accessed from the database. In a further embodiment, the electronic content is related to other physical locations of brick and mortar store 105. In another preferred embodiment, the product information is related to a proximity entry time, exit time and/or dwell time. In this case, the entry time, exit time and/or dwell time is correlated to a set of product types stored in and accessed from the database. Intermediary server device 120 correlates the identification number to a beacon location from a table in the database. At step 365, the electronic content is sent to patron device 110.

At step 366, the intermediary server device accesses a dwell time. In a preferred embodiment, if a patron is located in a perimeter for more than ten seconds, a second signal is sent from the patron to intermediary server indicating the dwell time of the patron device in the perimeter. Other dwell times may suffice. At step 367, the intermediary server chooses electronic content based on the dwell time. In a preferred embodiment, as the dwell time increases, the value of a coupon included with the electronic content is also increased. In another embodiment, the value of the coupon may be decreased with increasing dwell time. In another preferred embodiment, electronic content related to increasingly distantly related products is chosen based on increasing dwell time. Increasing and decreasing coupon values are stored according to tables correlated to dwell times which are stored in the database. Similarly, electronic content for related products is stored in a database correlated to dwell times.

At step 368, the electronic content chosen based on dwell time is sent to the patron.

At step 369, the intermediary server accesses an exit time indicating when the patron has left the perimeter of the beacon.

At step 370, the intermediary server chooses the electronic content based on the exit from the perimeter. In a preferred embodiment, a coupon value may be increased or decreased based on the perimeter exit. Similarly, the electronic content may be changed to indicate more closely or more distantly related products based on the perimeter exit.

At step 372, the intermediary server logs the perimeter path in the database. In a preferred embodiment, the perimeter path is a sequential listing of the perimeters visited, time entered, a dwell time within each perimeter, and an exit time from each perimeter stored in the database.

At step 374, the intermediary server chooses electronic content based on the perimeter path. In a preferred embodiment, the various combinations and permutations of perimeter paths each are correlated to a specific product, location or other content stored in the database. In another preferred embodiment, the database stores a pointer to files such as text files, html files, video files, mp3 files, or B-port files which are delivered based on the perimeter path.

At step 376, the content chosen in step 374 is sent to the patron device.

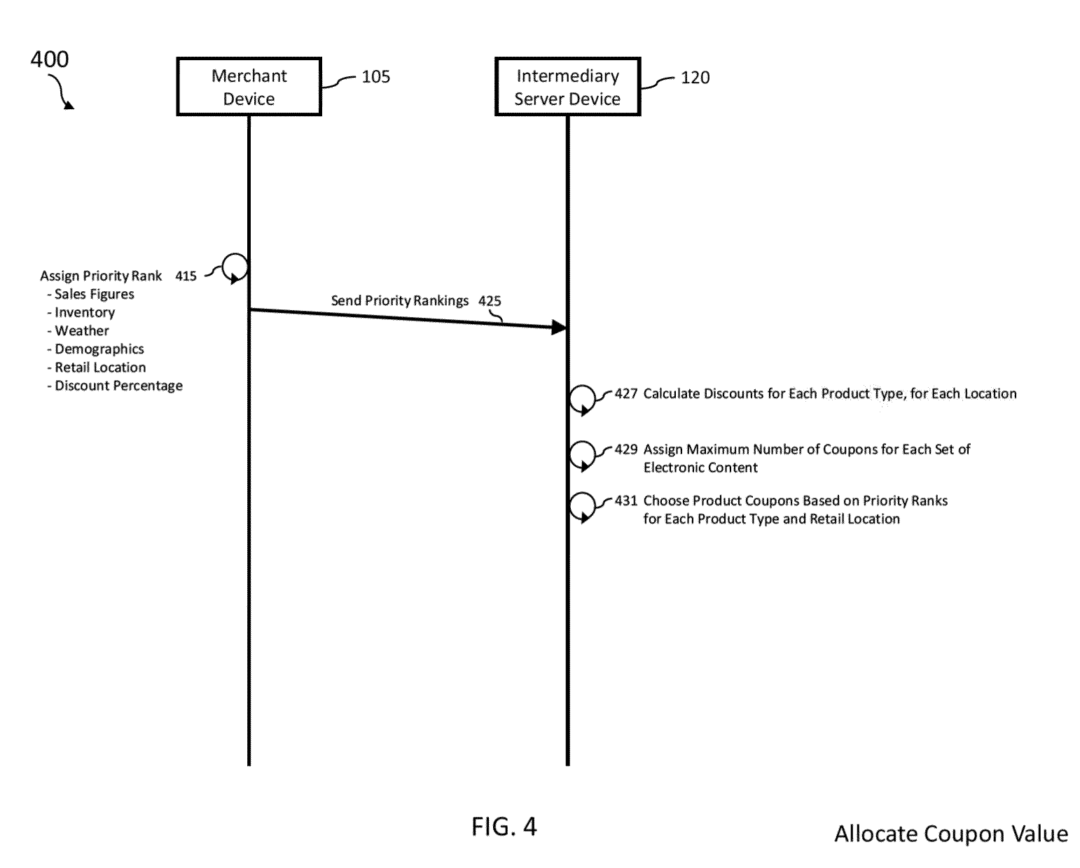

Referring to FIG. 4, method 400 for prioritizing product types for the electronic content will be described.

At step 415, merchant device 105 assigns priority rankings to the categories of sales figures, inventory, weather, demographics, retail locations, and discount percentage. In a preferred embodiment, the rankings are numerical with highest number being the highest priority and the lowest number being the lowest priority. At step 425, the priority rankings are sent to intermediary server device 120.

At step 427, intermediary server device 120 calculates all discounts for each product type and for each location, as previously described. At step 429, intermediary server device 120 assigns a maximum of product type coupons for each set of electronic content. At step 431, intermediary server device 120 chooses the product types on which to offer coupons in each set of electronic content based on the priority rankings for each product type in each brick and mortar store. In a preferred embodiment, the product types which fall into the highest ranking categories are chosen first. If an insufficient number of product types fall into the prioritized type categories, then product types from the lower priorities are chosen, in descending order, until the maximum number of coupons is reached for each set of electronic content. As seen, the set of priority rankings is transformed into a set of graphical included product types for the electronic content.

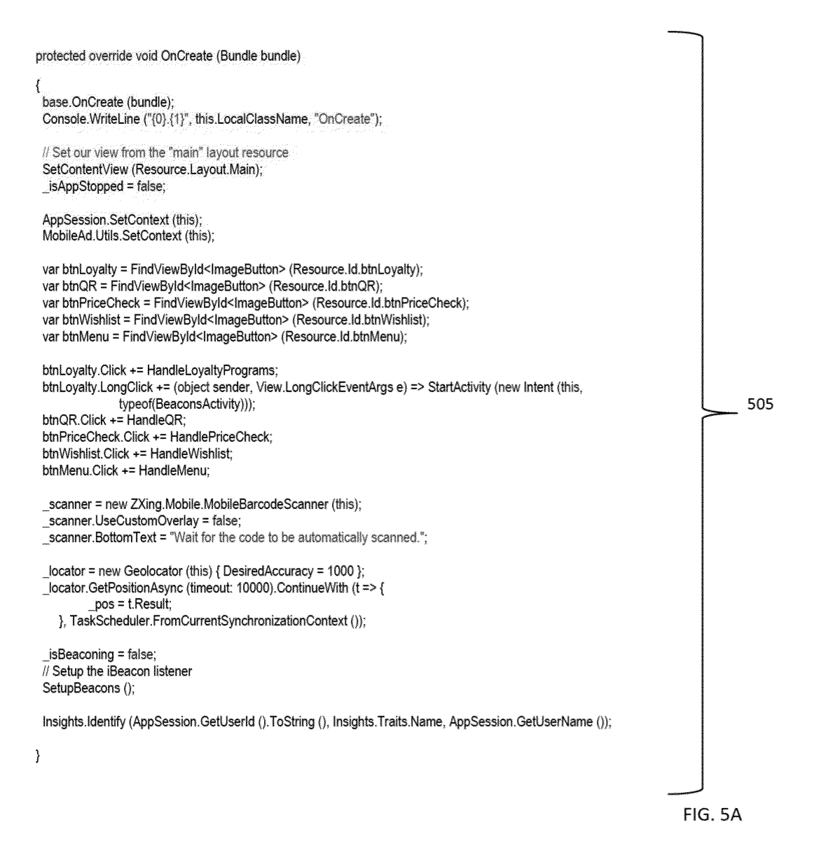

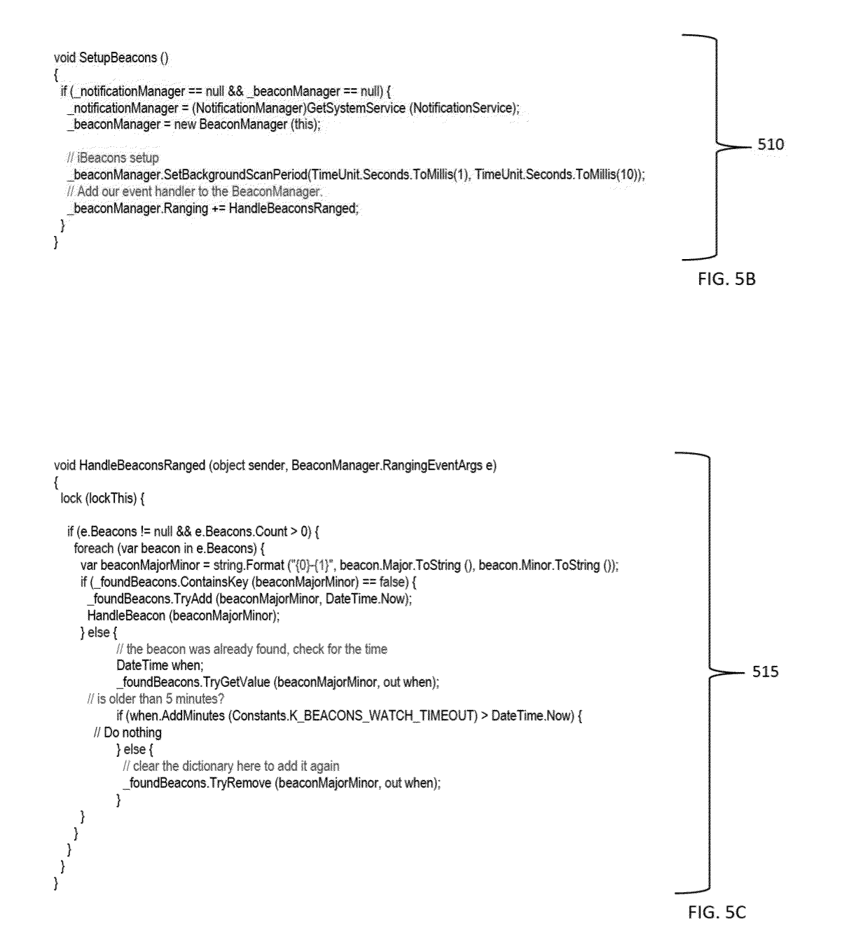

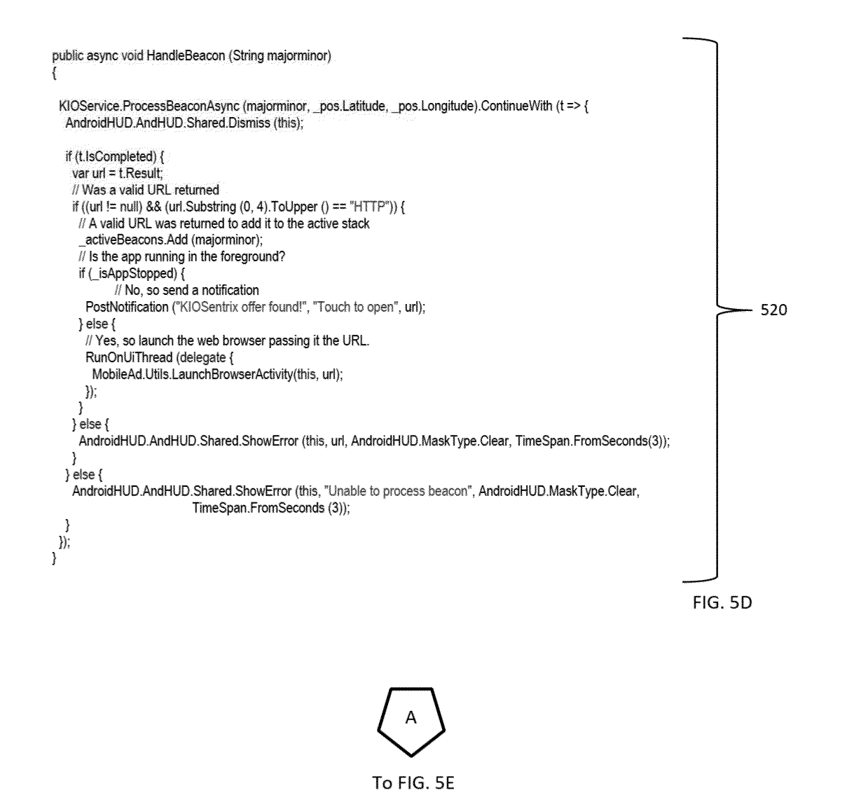

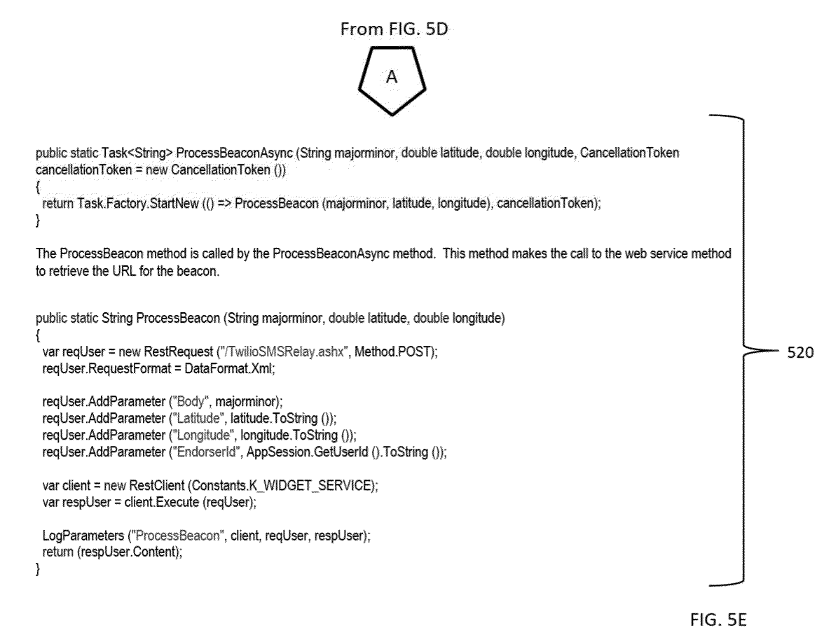

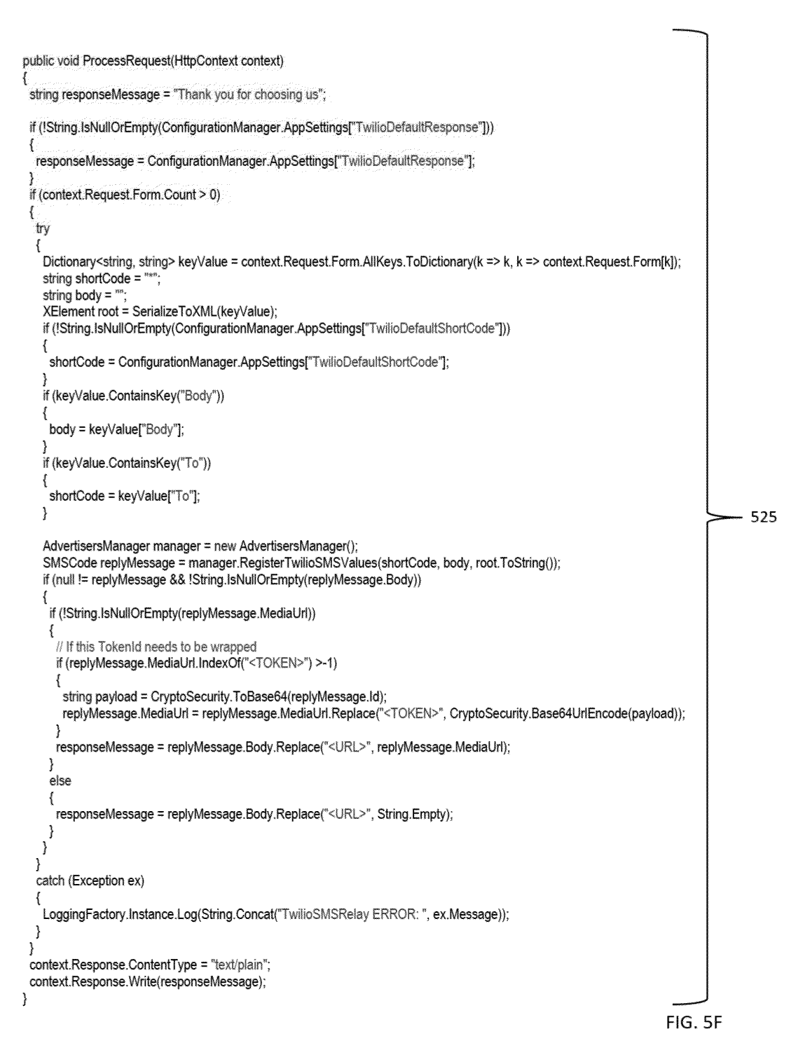

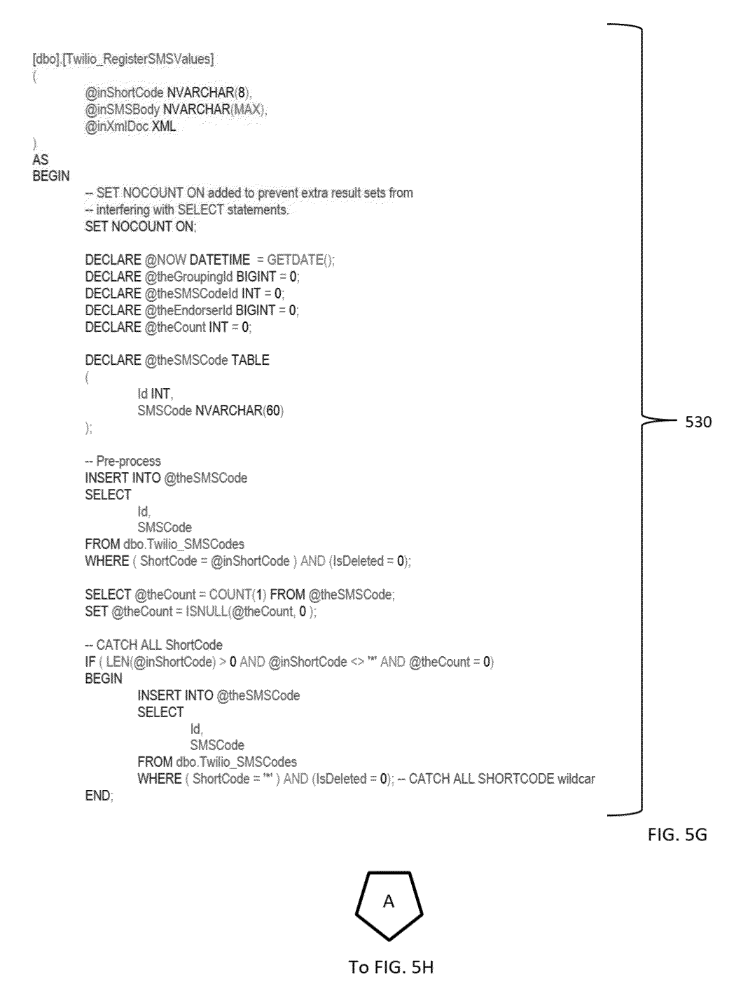

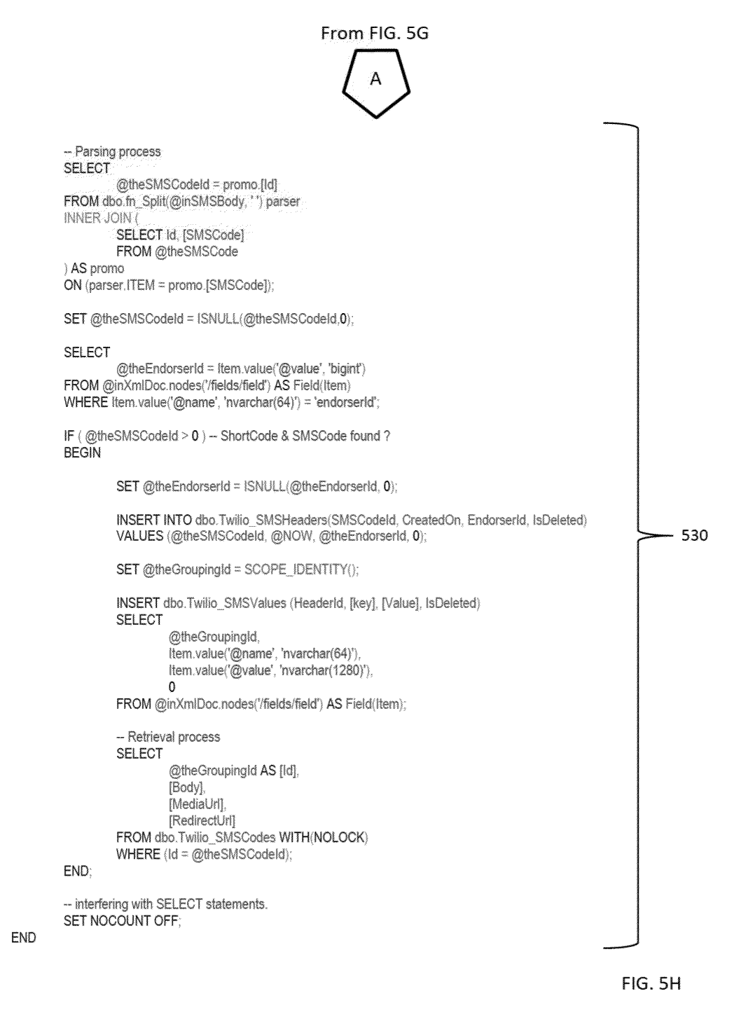

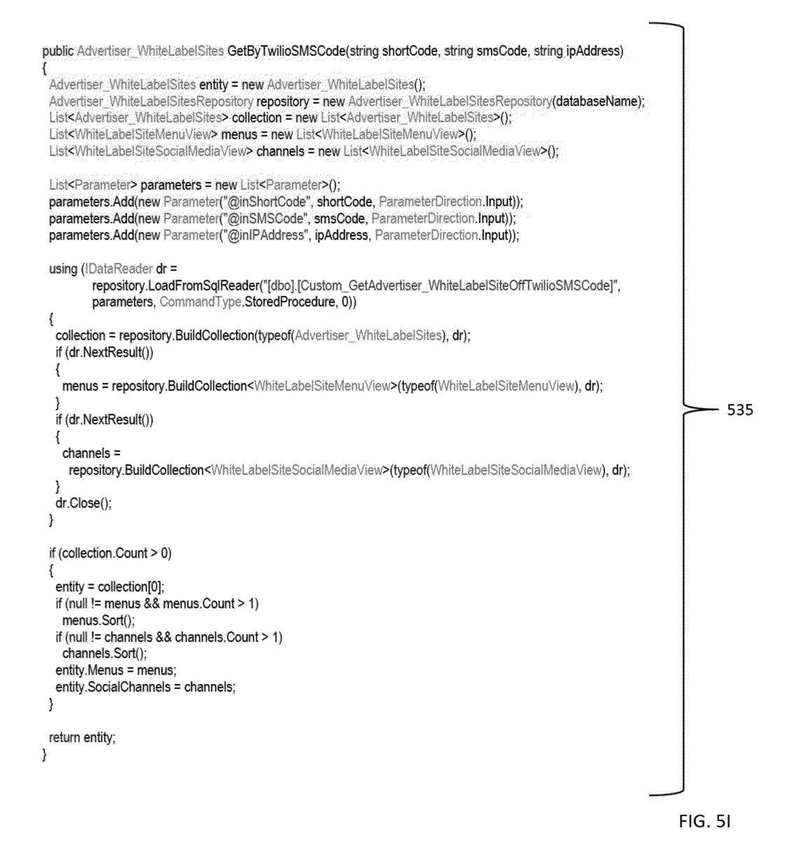

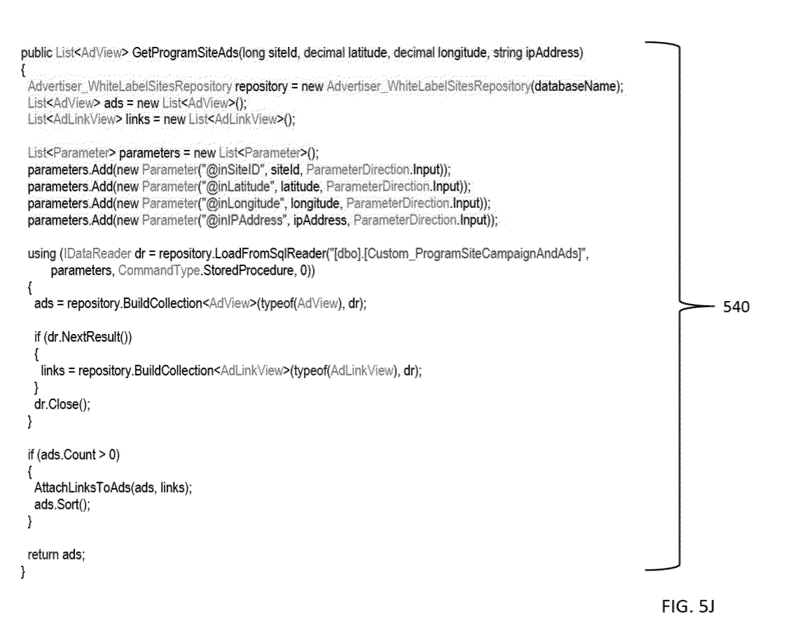

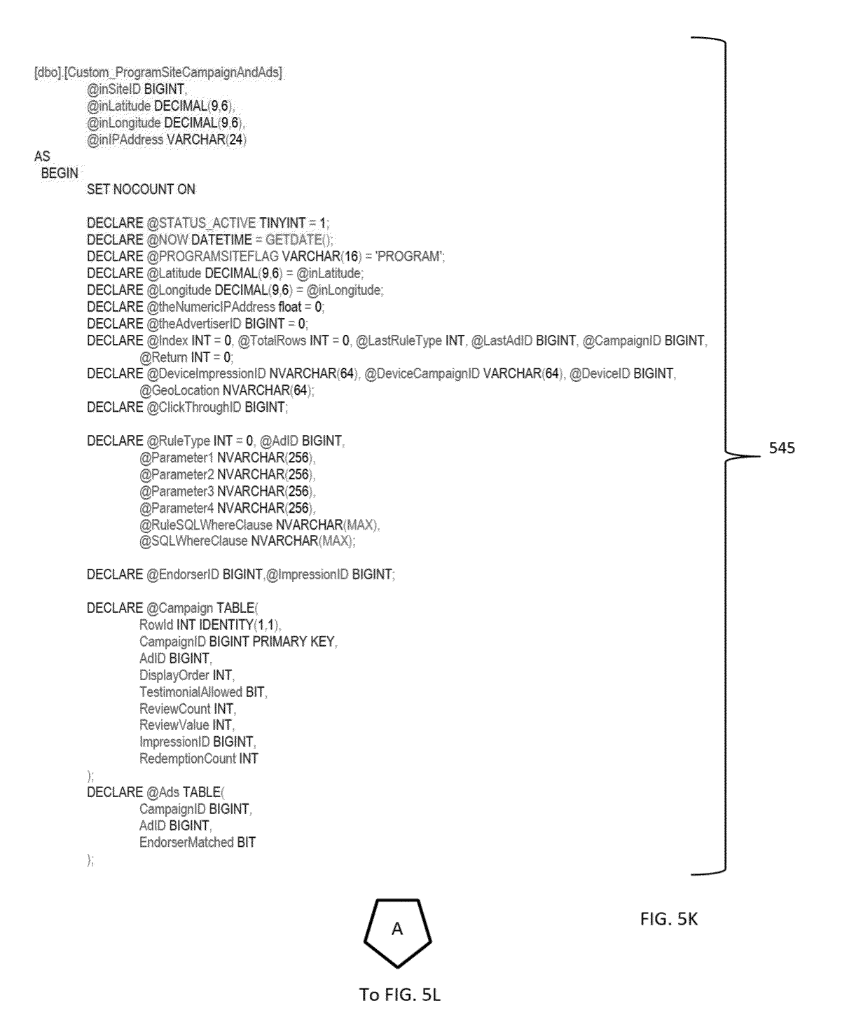

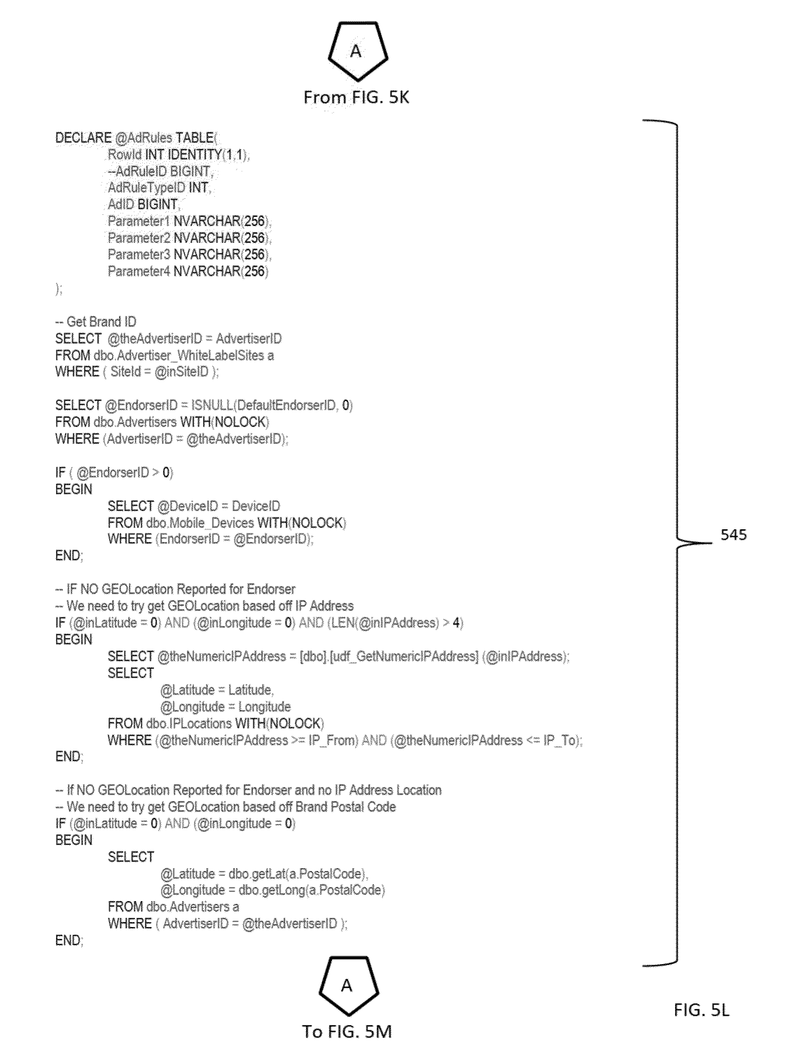

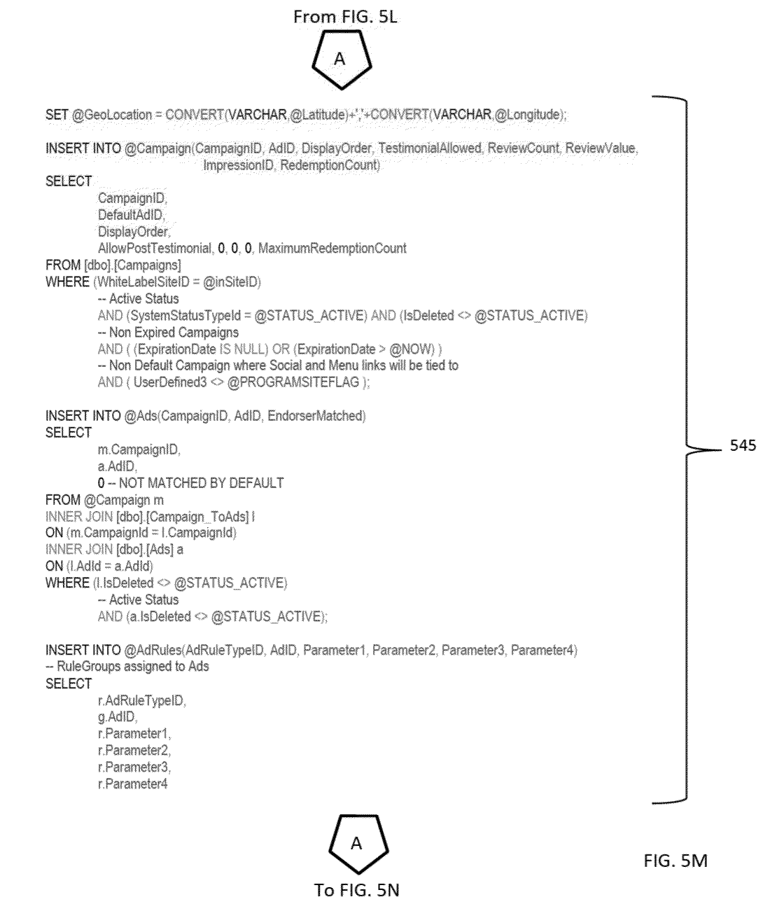

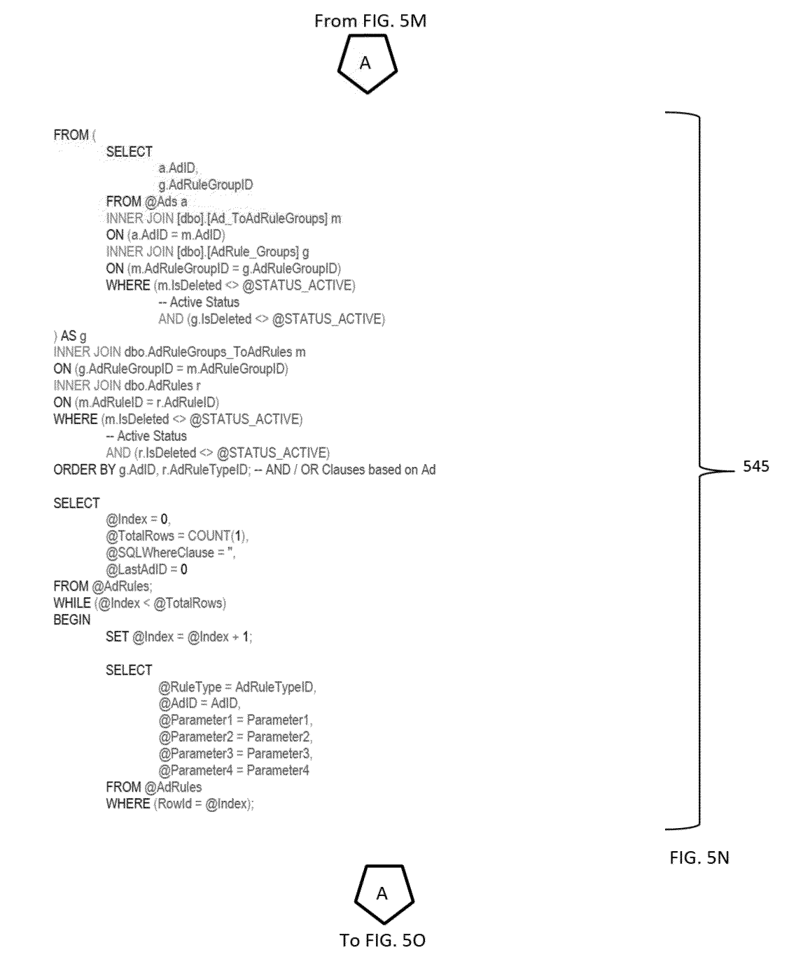

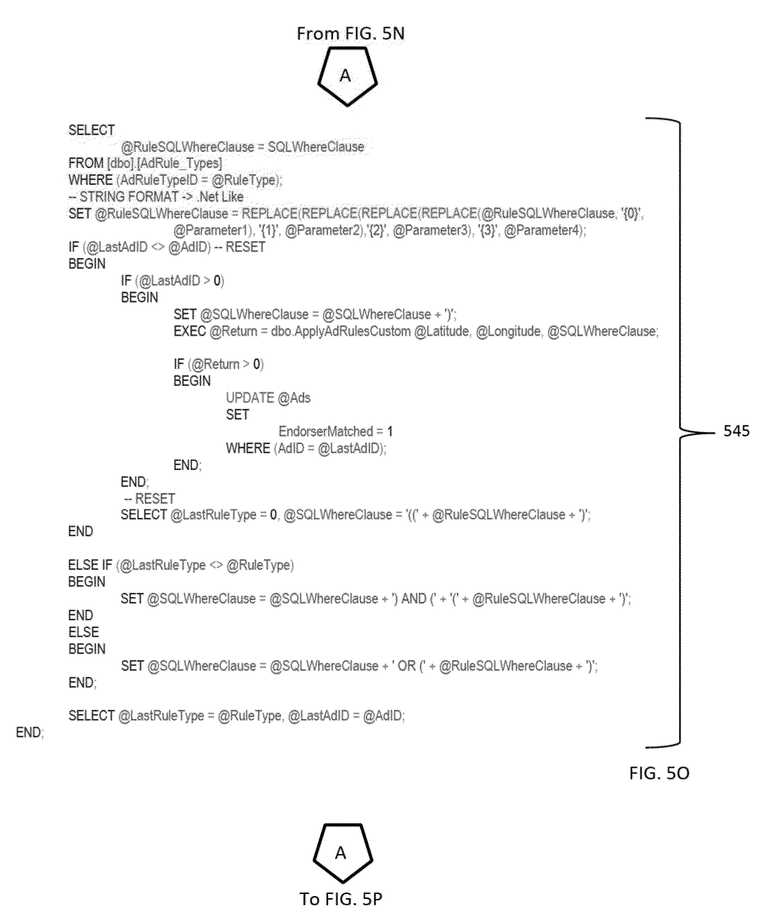

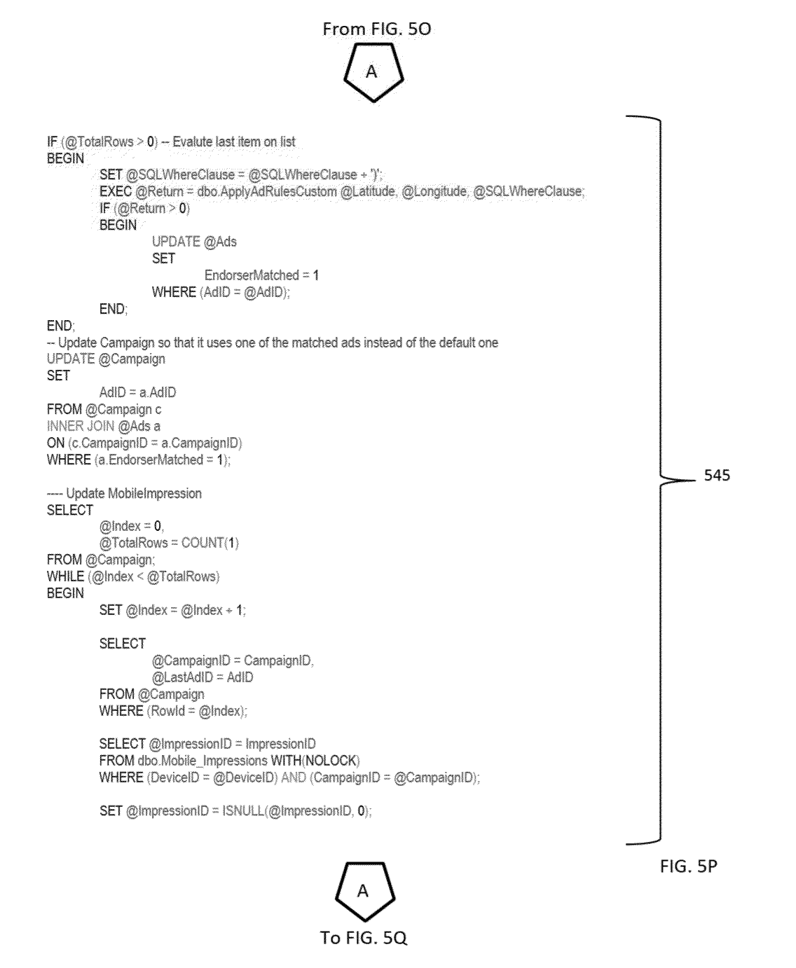

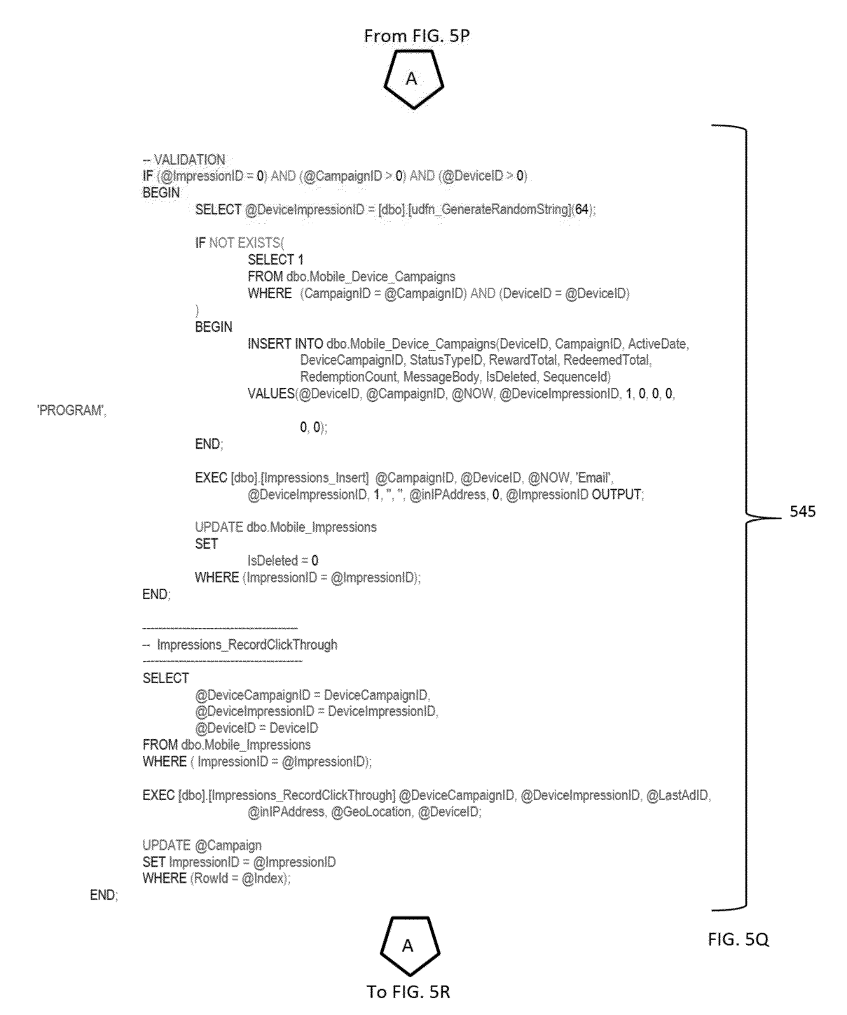

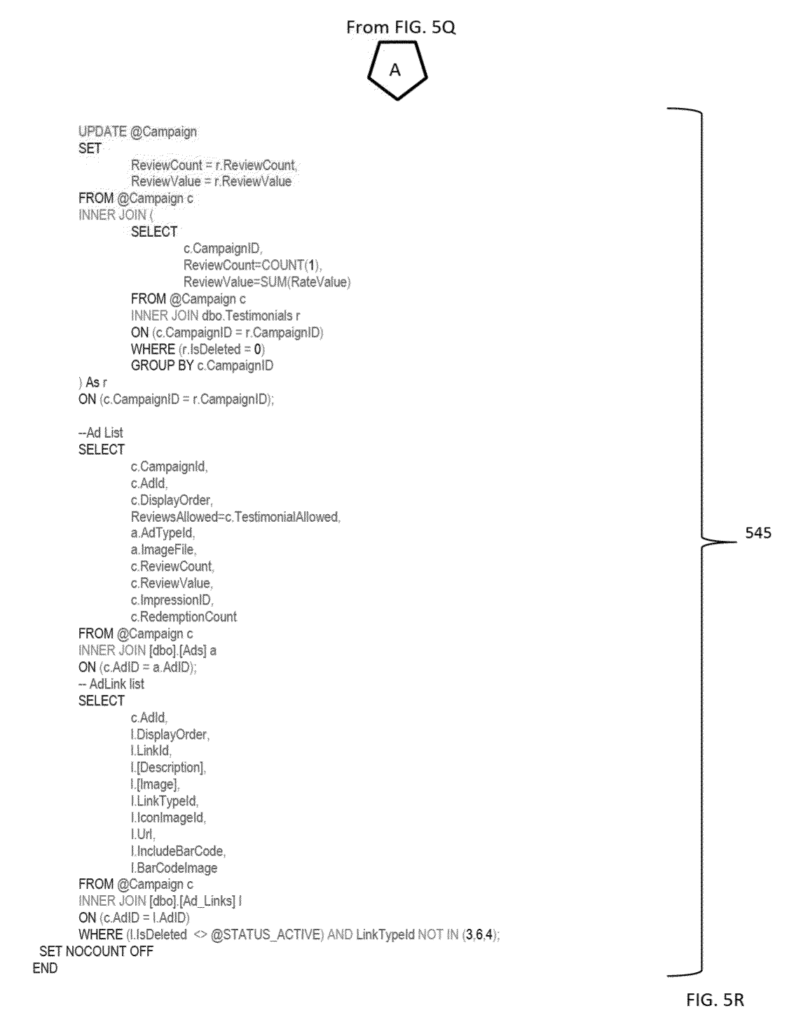

Referring then to FIGS. 5A-5R, an example of code which carries out a preferred method of step 284.

At 505, the “on create” method is executed when the application launches.

At 510, the “setup beacons” method is called from the “on create” method which instantiates the event handler for handling beacon signals.

At 515, a preferred method of carrying out steps 287 and 288 is described. At 515, the method “handle beacons ranged” is added as an event handler to the beacon manager and performs initial beacon processing. This method is called by the operating system when a beacon is found and determines whether or not the beacon has been previously processed within a period of time. If it has not been previously processed then it calls the “handle beacon” method to process the beacon discovered.

At 520, a preferred method of executing step 289 is described. At 520, the “handle beacon” method is called by the “handle beacons ranged” method. The handle beacon method calls the “process beacon async” method which returns a URL and launches the web browser passing it the URL.

At 525, a preferred method of carrying steps 290-307 is described.

At 525, the process request method is executed in a web service running on the intermediary service device. The process request method is called by the process beacon method running on the patron device and is passed the beacon ID. The process request method then records the beacon event and generates the URL which is passed back to the calling device.

At 530, a stored procedure is set out which is called by the process request method. The stored procedure records the beacon event and returns a data set which is used by the process request method to build the URL.

At 535, the GetByTwilioSMSCodes method retrieves the electronic content based on the parameters passed to it from step 290.

At 540, the GetProgramSiteAds method builds the content for the webpage that will be sent to the patron device for rendering. It calls the custom program site campaign and ads stored procedure which inserts the location, weather, demographic and other rules to determine the content to include.

At 545, the custom program site campaign and ads stored procedure applies the location, weather, demographic and other rules to the available content to determine which content to include in the page.

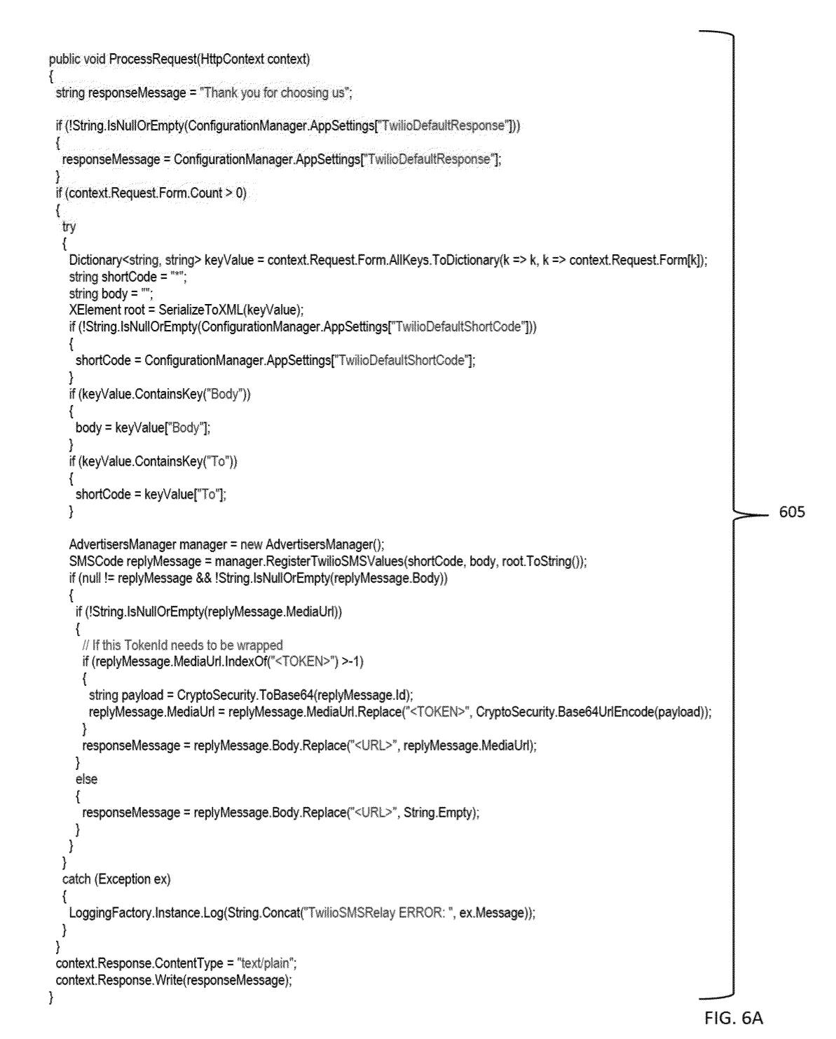

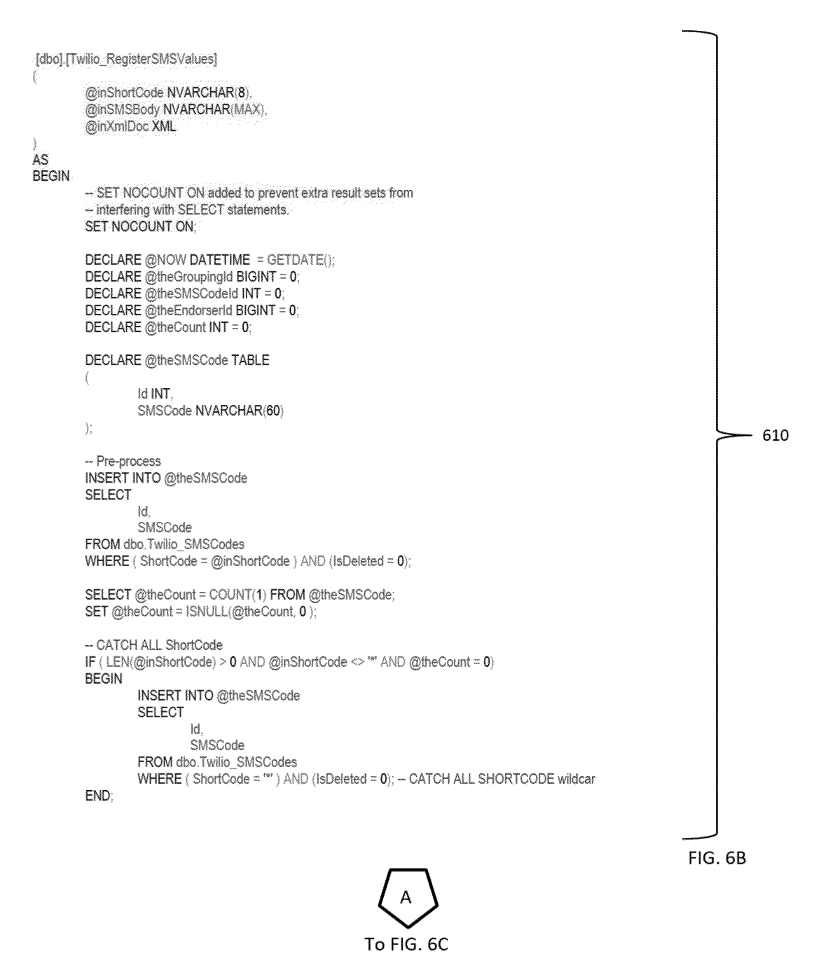

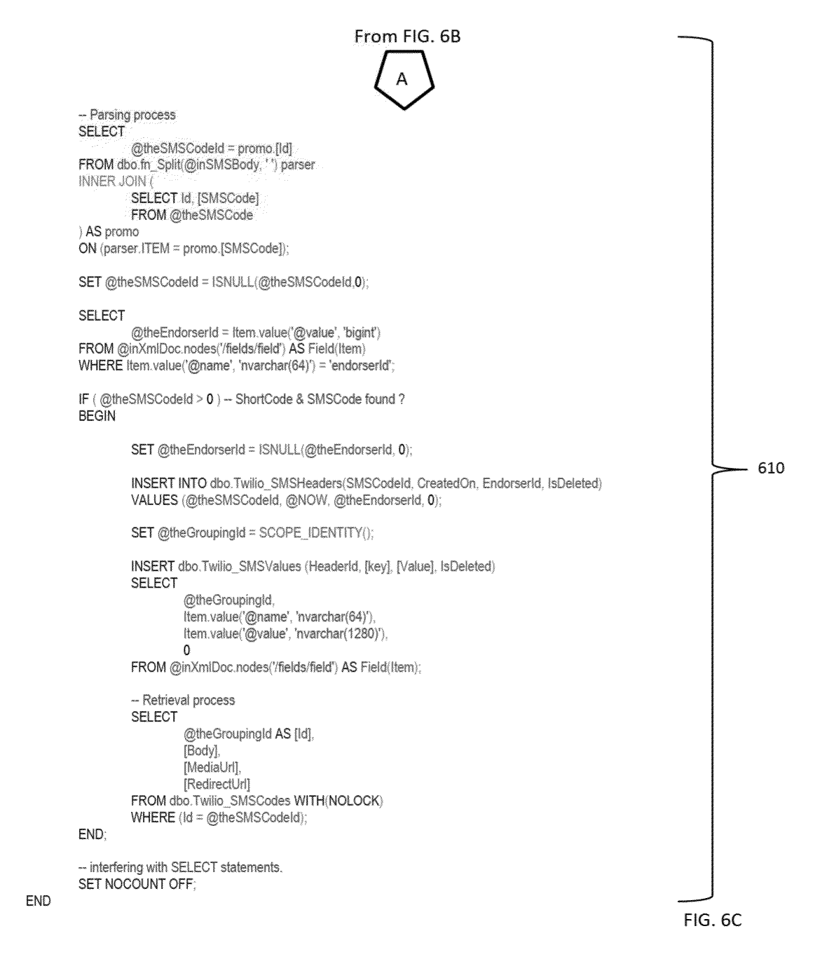

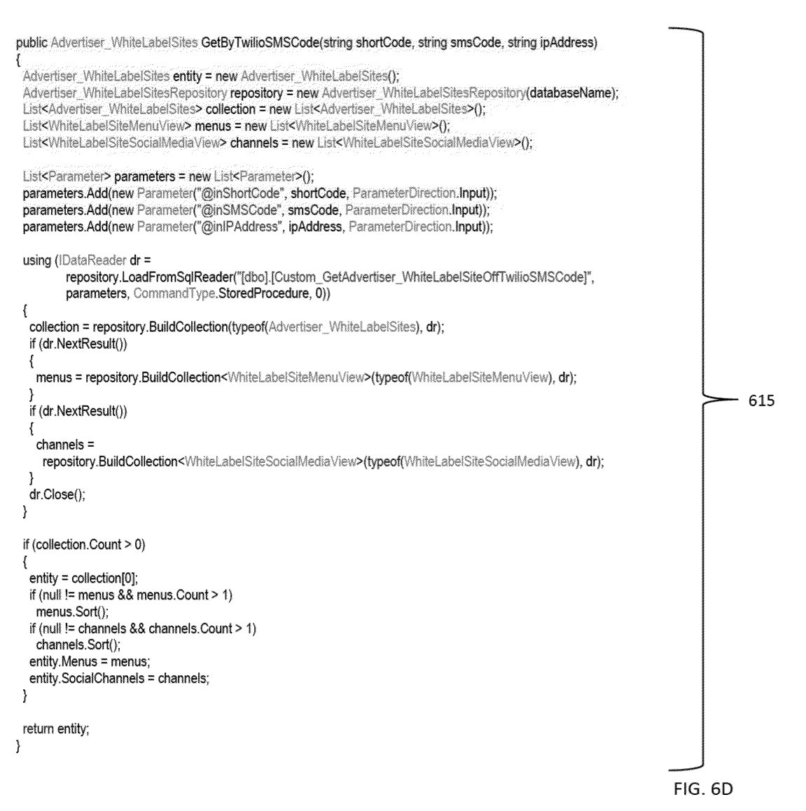

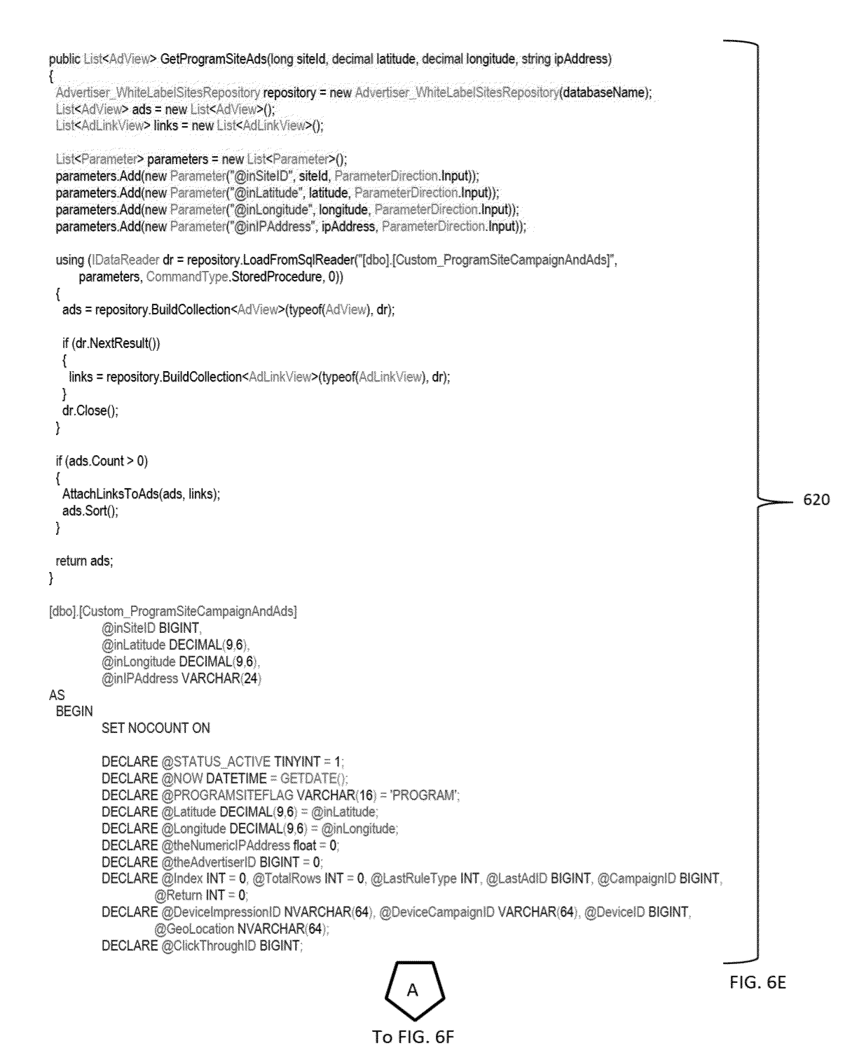

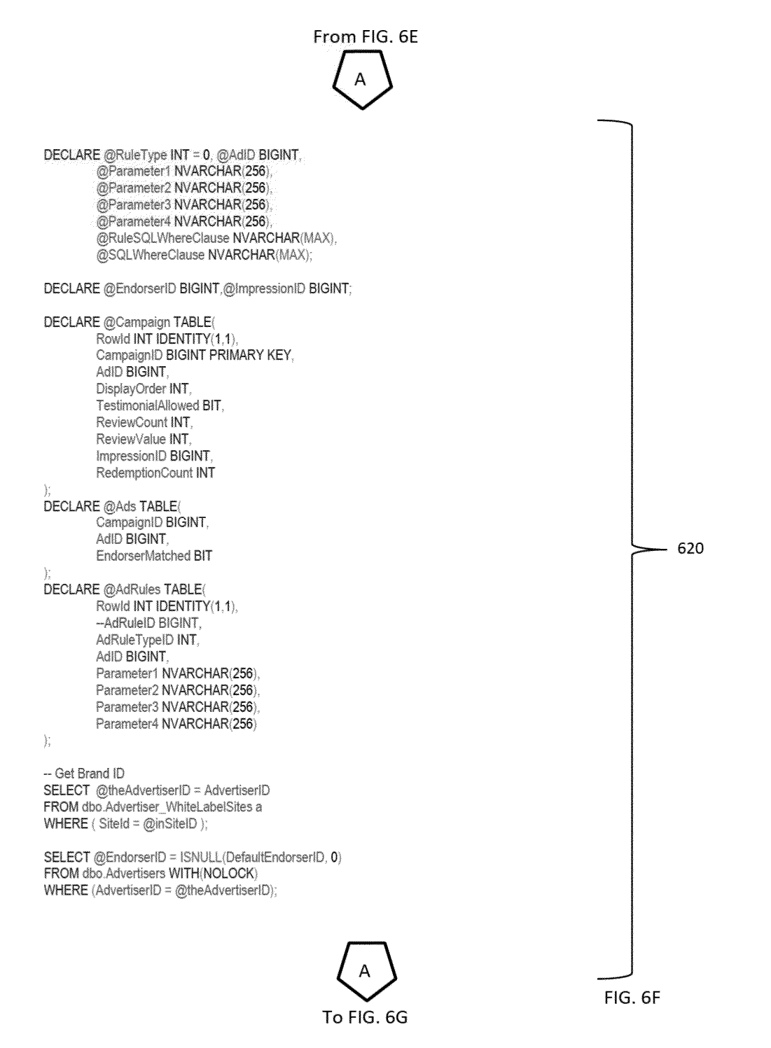

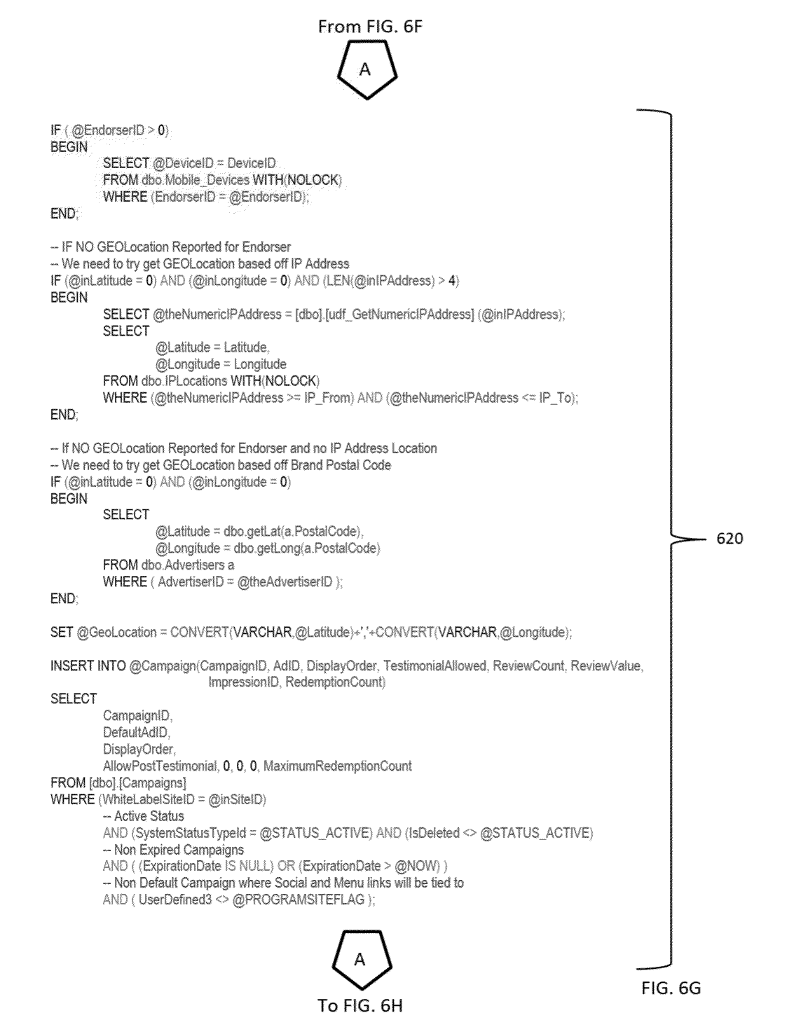

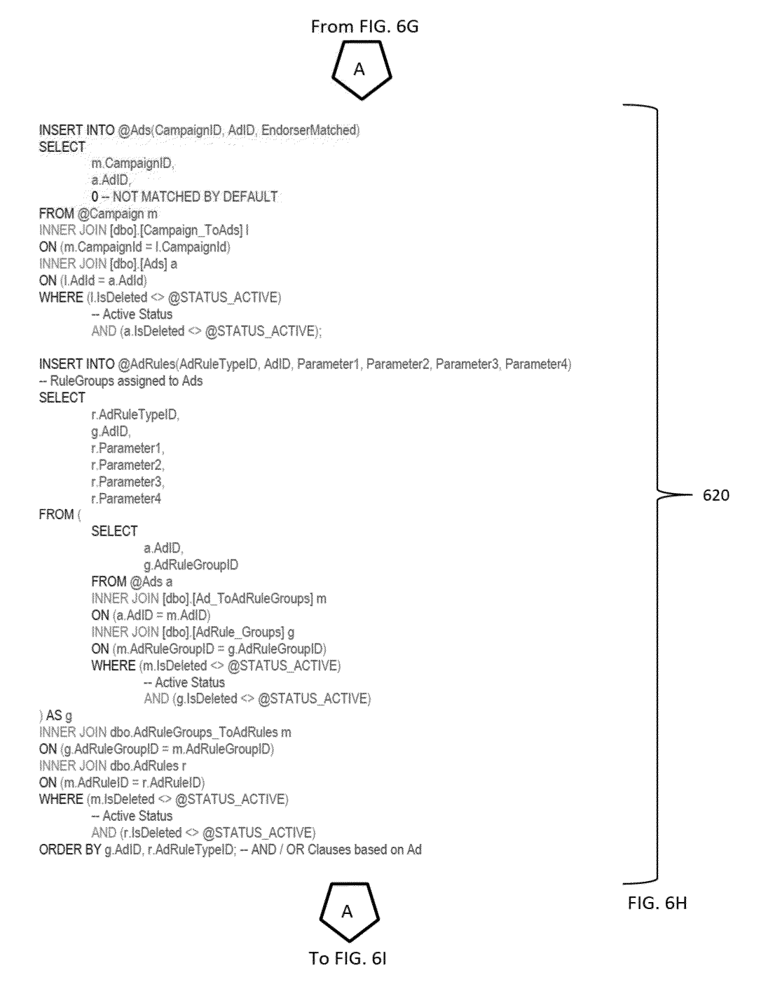

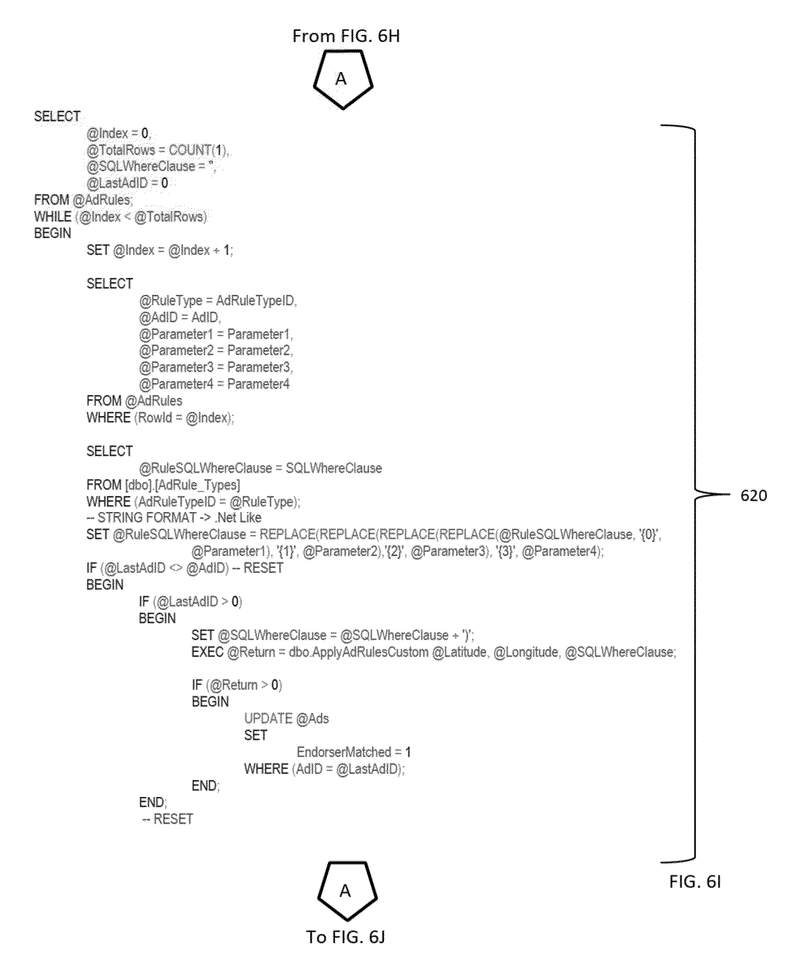

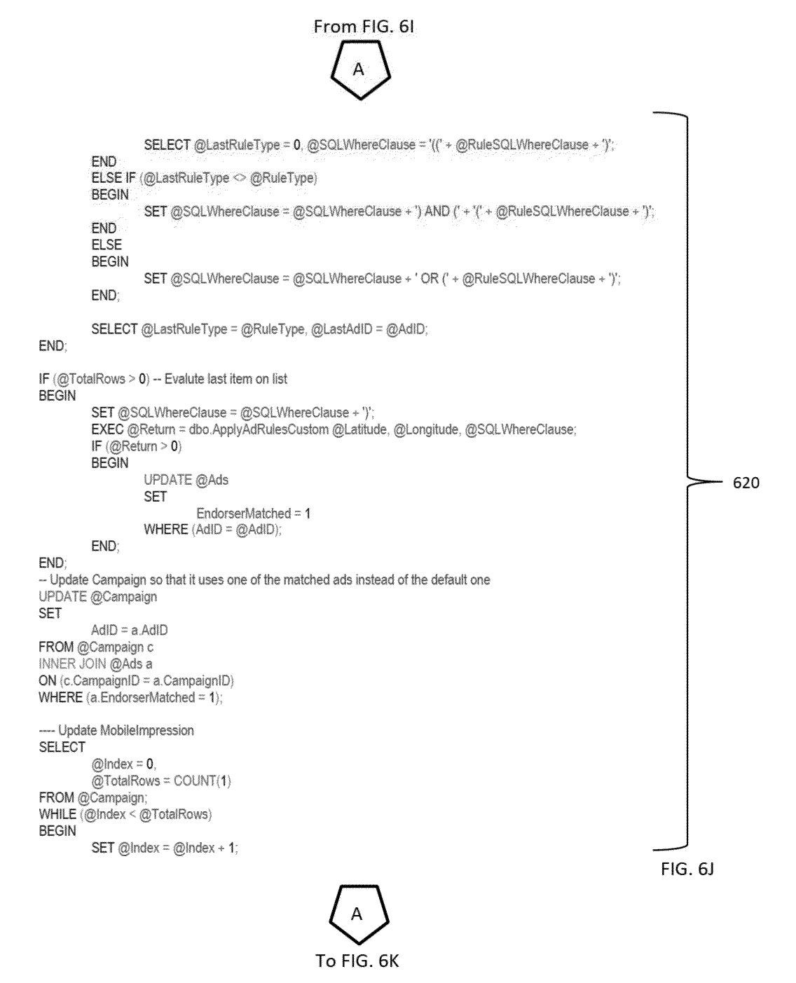

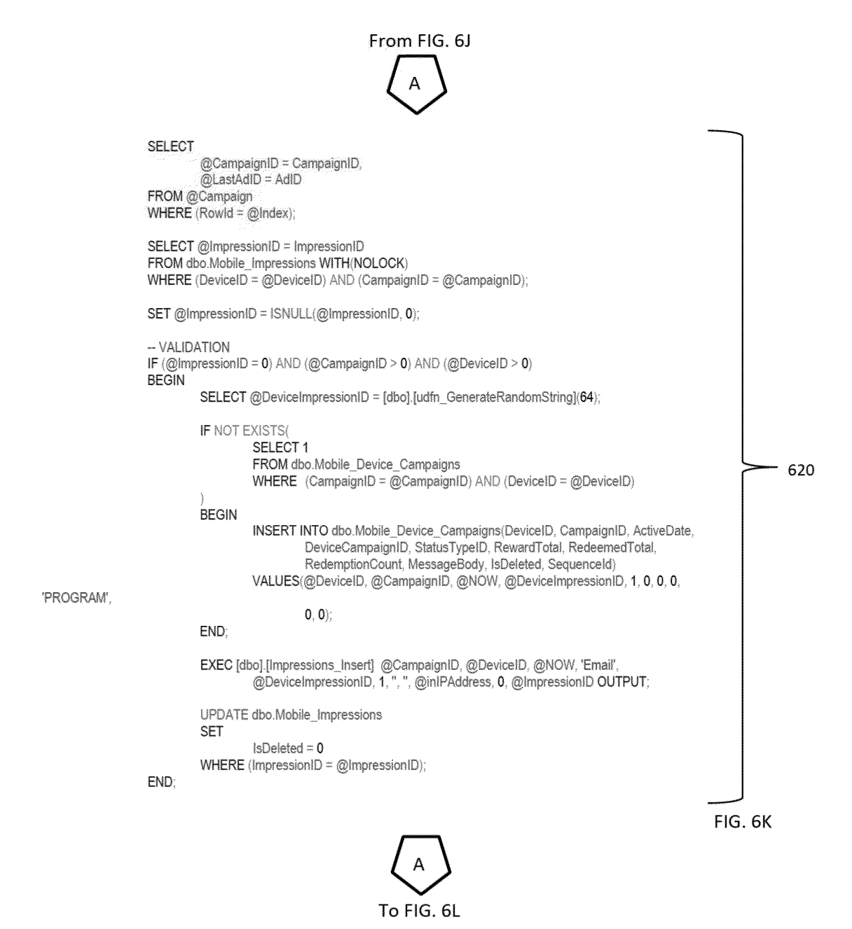

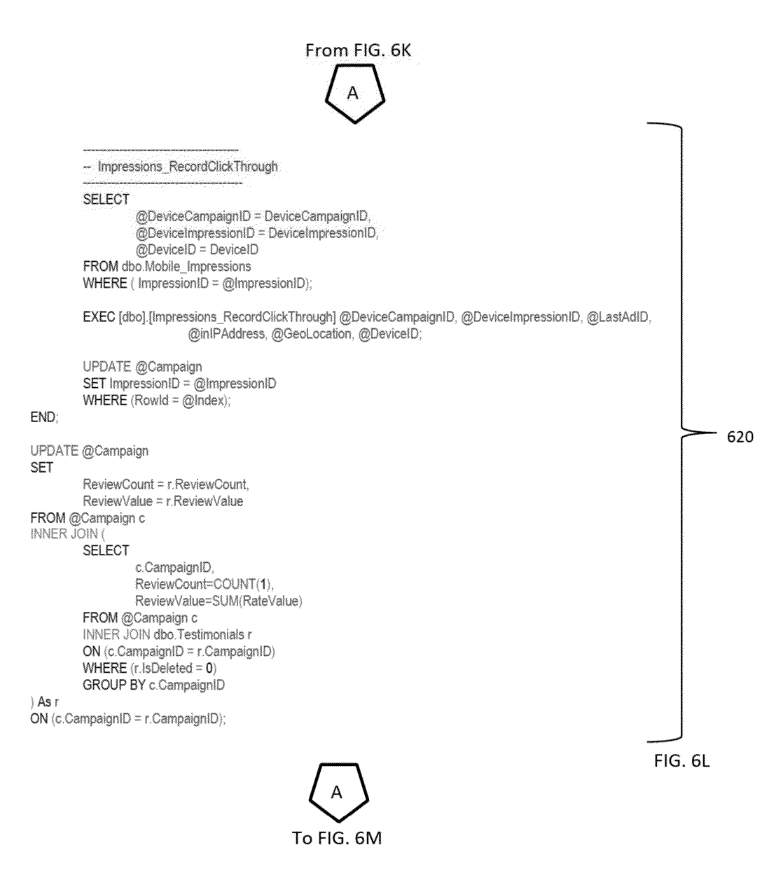

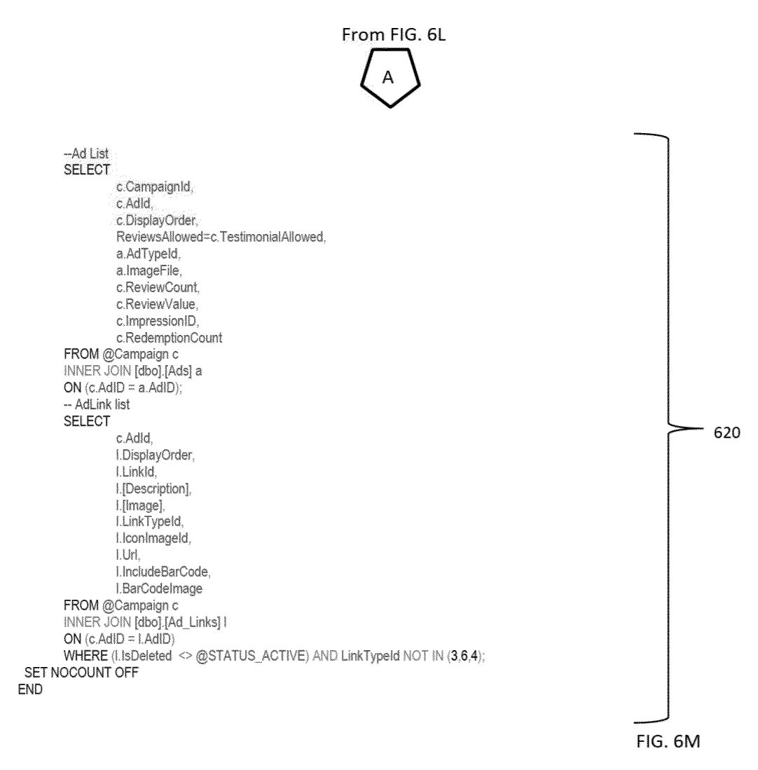

Referring then to FIGS. 6A-6M, an example of preferred computer code to generate electronic content is described.

At 605, the process request method runs on the intermediary server device and is called on the SMS provider and is passed the body of the text message, the short code and the phone number. This method records the SMS event and generates the URL which is sent back to the SMS provider who forwards it to the calling device via SMS.

At 610, a stored procedure is shown which is called by the process request method. The stored procedure records the SMS event and returns a data set which is used by the process request method to build the URL.

At 615, an example of computer code will be described which carries out steps 320, 328 and 330.

At 615, the GetByTwilioSMSCodes method retrieves electronic content based on the parameters passed to it in step 314.

At 620, the GetProgramsSiteAds method builds the electronic content for the web page which will be sent to the patron device for rendering. It calls the custom program site campaigns and ads stored procedure which applies the location, weather, demographic data and other rules to determine the content to include.

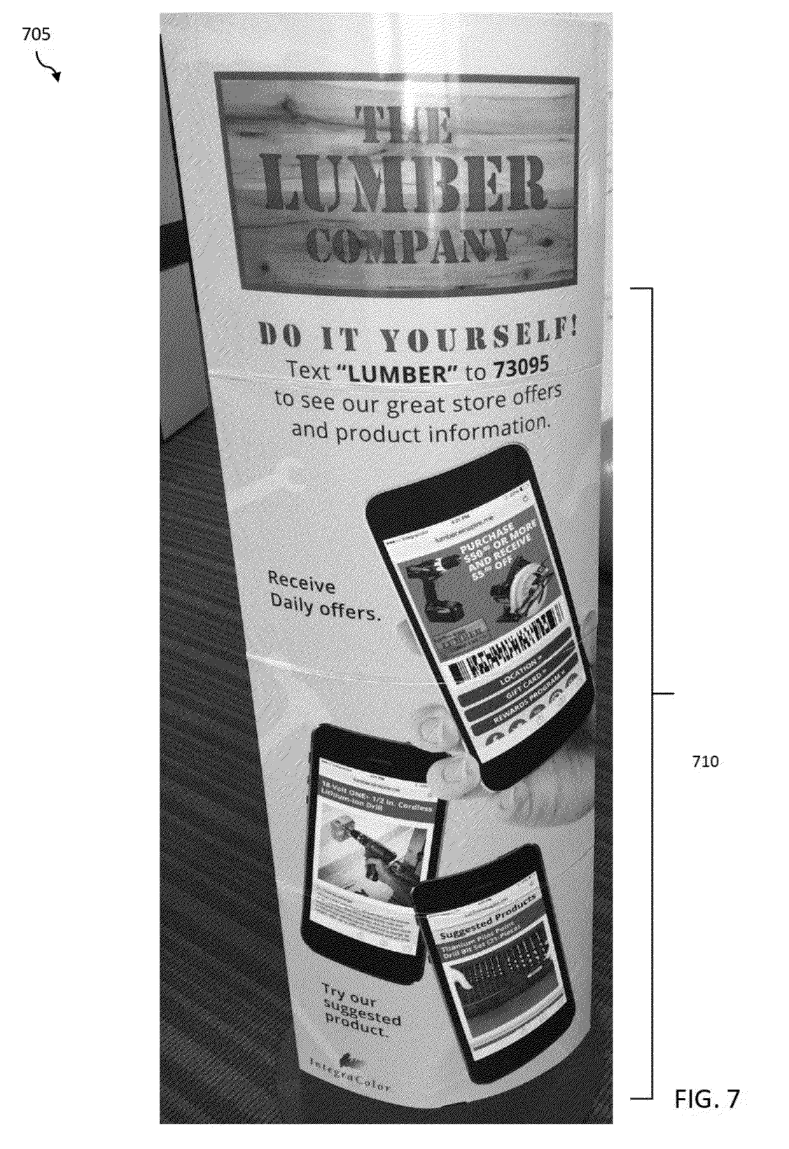

Referring then to FIG. 7, FIG. 7 depicts a preferred embodiment of a standalone static kiosk display 705 to be positioned in a store for observation by a patron. As can be seen, the kiosk display includes instructions 710 to the patron as to how to send a SMS text message to the system and how to receive electronic content.

The disclosure does not limit the functionality to either a web application or a mobile application. All of the features of the mobile application are accessible to a consumer through a web browser and vice versa.

It will be appreciated by those skilled in the art that the described embodiments disclose significantly more than an abstract idea including technical advancements in the field of data processing and a transformation of data which is directly related to real world objects and situations. Specifically, the disclosed embodiments efficiently and accurately generate and distribute electronic content by utilizing a specific set of rules or triggers. In this way, the electronic content accurately reflects the ability of the merchant device to fulfill purchases of the set of product types.

It will be appreciated by those skilled in the art that modifications can be made to the embodiments disclosed and remain within the inventive concept. Therefore, this invention is not limited to the specific embodiments disclosed, but is intended to cover changes within the scope and spirit of the claims.

1. A system for generating and distributing electronic content from a merchant device associated with a merchant and connected to a network, to a patron device associated with a patron and connected to the network, the system comprising:
an intermediary server device connected to the network;
the intermediary server device having a processor programmed to:
receive a set of electronic content setup data from the merchant device;
receive a request for electronic content from the patron device;
generate the electronic content from the electronic content setup data, in response to the request;
send the electronic content to the patron device.

2. The system of claim 1, wherein the processor is further programmed to:
receive a text message, from the patron device, as the request; and,
generate a URL in response to the text message.

3. The system of claim 1, wherein the electronic content setup information includes a geographic region trigger and a set of patron demographic data and the processor is further programmed to:
compare the geographic location trigger to the set of patron demographic data; and
send the electronic content if the geographic location trigger matches the set of patron demographic data.

4. The system of claim 1, wherein the electronic content setup information includes an inventory trigger and the processor is further programmed to:
receive a set of current inventory data;
compare the inventory trigger to the set of current inventory data; and,
send the electronic content if the current inventory data is equal to or greater than the inventory trigger.

5. The system of claim 1, wherein the electronic content setup data further includes a product type list and a percentage discount and the processor is further programmed to send an electronic coupon for a product type in the product type list and for the percentage discount.

6. The system of claim 1, wherein the electronic content setup data includes a recommended patron type and wherein the processor is further programmed to send the electronic coupon to a patron of the recommended patron type.

7. A system for generating and distributing to a patron device electronic content based on information from a merchant device, the patron device and the merchant device both connected by a network, the system comprising:
an intermediary server device, connected to the network, the intermediary server device programmed to:
receive a content device schedule;
receive a brick and mortar store list;
receive a percentage discount list;
receive a recommended patron type;
receive an existing patron list;
compare the current device schedule to the current date and time;
determine a product type from the product type list;
determine a brick and mortar store from the brick and mortar store list;
determine a percentage discount from the percentage discount list;
determine a patron by comparing the recommended patron type to the existing patron list;
generate electronic content including the product type, the brick and mortar store, the percentage discount; and,
send the electronic content to a patron associated with the patron device.

8. The system of claim 7, wherein the intermediary server device is further programmed to:
receive a weather trigger;
receive current weather data;
receive an inventory trigger;
receive current inventory data;
compare the weather trigger to the current weather data;
compare the inventory trigger to the inventory data; and,
generate the electronic content if the weather trigger matches the weather data and the inventory data matches the inventory data.

9. The system of claim 7, wherein the intermediary server device is further programmed to:
receive a geographic region list;
receive a geographic region trigger;
compare the geographic region list with the geographic region trigger; and,
generate the electronic content if the geographic region trigger is in the geographic region list.

10. A system for generating and distributing electronic content to a patron device from an intermediary server device, wherein the intermediary server device is programmed to:
receive a beacon identification number;
correlate the identification number to a physical location;
determine electronic content based on the physical location; and,
send the electronic content to the patron device.

11. The system of claim 10, wherein the intermediary server device is further programmed to;
receive a dwell time; and,
determine the electronic content based on the dwell time.

12. The system of claim 10, wherein the intermediary server device is further programmed to:
receive an entry time; and,
determine the electronic content based on the entry time.

13. The system of claim 10 wherein the intermediary server device is further programmed to;
receive an exit time; and,
determine the electronic content based on the exit time.

14. The system of claim 1 wherein the intermediary server device is further programmed to;
receive a perimeter path; and,
determine the electronic content based on the perimeter path.

15. A method for generating and distributing electronic content comprising the steps of:
evaluating a content device schedule for a send time;
evaluating a weather trigger for a set of weather conditions;
evaluating an inventory level for an inventory tolerance;
choosing a store location;
choosing a product type;
choosing an eligible patron identity from a set of eligible patron identities;
assembling the electronic content based on the store location and product type; and,
sending the electronic content at the send time, if the set of weather conditions match the weather trigger and the inventory level is within the inventory tolerance.

16. The method of claim 15, further comprising the steps of:
choosing store artwork;
choosing product artwork; and,
incorporating the store artwork and the product artwork into the electronic content.

17. The method of claim 15, wherein the eligible patron identity includes a set of demographic information and further comprising the step of assembling the electronic content based in part on the demographic information.
